(19) United States
(12) Patent Application Publication
(10) Pub. No.: US 2023/0085590 A1
(43) Pub. Date: Mar. 16, 2023

(54) IMAGE PROCESSING APPARATUS, IMAGE PROCESSING METHOD, AND PROGRAM

(71) Applicant: FUJIFILM Corporation, Tokyo (JP)

(72) Inventors: Kazunori TAMURA, Saitama-shi (JP); Fuminori IRIE, Saitama-shi (JP); Takashi AOKI, Saitama-shi (JP); Masahiko MIYATA, Saitama-shi (JP); Yasunori MURAKAMI, Saitama-shi (JP)

(73) Assignee: FUJIFILM Corporation, Tokyo (JP)

(21) Appl. No.: 18/049,637

(22) Filed: Oct. 26, 2022

Related U.S. Application Data
(63) Continuation of application No. PCT/JP2021/016071, filed on Apr. 20, 2021.

(30) Foreign Application Priority Data
Apr. 28, 2020 (JP) 2020-079535

(51) Int. Cl. H04N 21/4728; H04N 21/482; H04N 21/8545

(52) U.S. Cl. CPC H04N 21/4728; H04N 21/482; H04N 21/8545

(57) ABSTRACT

An image processing apparatus includes a processor and a memory built in or connected to the processor, in which wherein the processor acquires specific region information indicating a specific region designated in an imaging region image screen on which an imaging region image obtained by imaging an imaging region is displayed, and outputs a specific region processed image obtained by processing an image corresponding to the specific region indicated by the specific region information among a plurality of images obtained by imaging the imaging region.

### CROSS-REFERENCE TO RELATED APPLICATIONS

This application is a continuation application of International Application No. PCT/JP2021/016071, filed Apr. 20, 2021, the disclosure of which is incorporated herein by reference in its entirety. Further, this application claims priority under 35 USC 119 from Japanese Patent Application No. 2020-079535 filed Apr. 28, 2020, the disclosure of which is incorporated by reference herein.

### BACKGROUND

### 1. Technical Field

The techniques of the present disclosure relate to an image processing apparatus, an image processing method, and a program.

### 2. Related Art

JP2003-283450A discloses a receiving device that receives content transmitted by a content transmission device via a broadcast wave with a predetermined broadcasting band or a communication line. The receiving device disclosed in JP2003-283450A includes an information receiving unit, a designation reception unit, a transmission unit, a detection unit, and a content receiving unit.

The information receiving unit receives content specifying information that specifies receivable content and broadcast content information that indicates content that is being broadcast by a broadcast wave with a predetermined broadcast band. The designation reception unit receives designation of at least one piece of content from a user among the pieces of receivable content. The transmission unit transmits the content specifying information that specifies the content related to the designation to the content transmission device via the communication line. The detection unit refers to the broadcast content information and detects whether or not the content related to the designation is being broadcast by the broadcast wave with the predetermined broadcast band. In a case where the detection unit detects that the content related to the designation is not broadcast, the content receiving unit receives content specified by the content specifying information transmitted by the transmission unit from the content transmission device via the communication line.

The receiving device disclosed in JP2003-283450A is a receiving device that displays the received content on a display device, and includes a display unit that displays a list of receivable content on the display device on the basis of the content specifying information. The designation reception unit receives designation of at least one piece of content specifying information from the user from the list displayed by the display unit.

### SUMMARY

One embodiment according to the technique of the present disclosure provides an image processing apparatus, an image processing method, and a program enabling a viewer of an imaging region image obtained by imaging an imaging region to view a specific region processed image obtained by processing an image corresponding to a specific region designated in the imaging region image.

A first aspect according to the technique of the present disclosure is an image processing apparatus including a processor; and a memory built in or connected to the processor, in which the processor acquires specific region information indicating a specific region designated in an imaging region image screen on which an imaging region image obtained by imaging an imaging region is displayed, and outputs a specific region processed image obtained by processing an image corresponding to the specific region indicated by the specific region information among a plurality of images obtained by imaging the imaging region.

A second aspect according to the technique of the present disclosure is the image processing apparatus according to the first aspect in which the imaging region image screen is a screen obtained by imaging another screen on which the imaging region image is displayed.

A third aspect according to the technique of the present disclosure is the image processing apparatus according to the first aspect or the second aspect in which the imaging region image includes a live broadcast video.

A fourth aspect according to the technique of the present disclosure is the image processing apparatus according to any one of the first aspect to the third aspect in which the imaging region image screen has a plurality of divided screens on which the imaging region image is displayed, and the specific region is designated by selecting any of the divided screens.

A fifth aspect according to the technique of the present disclosure is the image processing apparatus according to a fourth aspect in which the imaging region image is divided and displayed on the plurality of divided screens.

A sixth aspect according to the technique of the present disclosure is the image processing apparatus according to the fourth aspect in which the imaging region image is a plurality of unique images obtained by imaging the imaging region in different imaging methods, and the plurality of unique images are respectively and individually displayed on the plurality of divided screens.

A seventh aspect according to the technique of the present disclosure is the image processing apparatus according to any one of the fourth aspect to the sixth aspect in which the plurality of divided screens are displayed separately on a plurality of displays.

An eighth aspect according to the technique of the present disclosure is any one of the first aspect to the seventh aspect in which the processor generates and outputs the specific region processed image with reference to a timing at which the specific region is designated.

A ninth aspect according to the technique of the present disclosure is the image processing apparatus according to any one of the first aspect to the eight aspect in which the imaging region image is displayed on a display as a frame-advancing motion picture, and the specific region is designated by selecting any of a plurality of frames configuring the frame-advancing motion picture.

A tenth aspect according to the technique of the present disclosure is the image processing apparatus according to any one of the first aspect to the ninth aspect in which, from a menu screen capable of specifying a plurality of imaging scenes in which at least one of a position, an orientation, or an angle of view at which imaging is performed on the imaging region is different, the specific region is designated by selecting any of the plurality of imaging scenes.

An eleventh aspect according to the technique of the present disclosure is the image processing apparatus according to any one of the first aspect to the tenth aspect in which a region corresponding to an object selected from object specifying information capable of specifying a plurality of objects included in the imaging region is designated as the specific region.

A twelfth aspect according to the technique of the present disclosure is the image processing apparatus according to any of the first aspect to the eleventh aspect in which the processor outputs the specific region processed image to a display device to display the specific region processed image on the display device.

A thirteenth aspect according to the technique of the present disclosure is the image processing apparatus according to any one of the first aspect to the twelfth aspect in which the processor changes processing details for an image for the specific region according to an instruction given from an outside.

A fourteenth aspect according to the technique of the present disclosure is the image processing apparatus according to any one of the first aspect to the thirteenth aspect in which the specific region processed image is a virtual viewpoint image.

A fifteenth aspect according to the technique of the present disclosure is an image processing method including acquiring specific region information indicating a specific region designated in an imaging region image screen on which an imaging region image obtained by imaging an imaging region is displayed; and outputting a specific region processed image obtained by processing an image corresponding to the specific region indicated by the specific region information among a plurality of images obtained by imaging the imaging region and including a virtual viewpoint image.

A sixteenth aspect according to the technique of the present disclosure is a program causing a computer to execute acquiring specific region information indicating a specific region designated in an imaging region image screen on which an imaging region image obtained by imaging an imaging region is displayed; and outputting a specific region processed image obtained by processing an image corresponding to the specific region indicated by the specific region information among a plurality of images obtained by imaging the imaging region and including a virtual viewpoint image.

### BRIEF DESCRIPTION OF THE DRAWINGS

Exemplary embodiments of the technology of the disclosure will be described in detail based on the following figures, wherein:

FIG. 1 is a schematic perspective view showing an example of an external configuration of an image processing system according to an embodiment;

FIG. 2 is a conceptual diagram showing an example of a virtual viewpoint image generated by the image processing system according to the embodiment;

FIG. 3 is a schematic plan view showing an example of an aspect in which a plurality of physical cameras and a plurality of virtual cameras used in the image processing system according to the embodiment are installed in a soccer stadium;

FIG. 4 is a block diagram showing an example of a hardware configuration of an electrical system of an image processing apparatus according to the embodiment;

FIG. 5 is a block diagram showing an example of a hardware configuration of an electrical system of a user device according to an embodiment;

FIG. 6 is a perspective view showing an example of the appearance of a television receiver included in the image processing system according to the embodiment;

FIG. 7 is a perspective view showing an example of an aspect in which a screen displayed on the television receiver is imaged by a physical camera of the user device;

FIG. 8 is a screen view showing an example of a physical camera motion picture screen obtained by imaging the screen displayed on the television receiver with physical camera of the user device;

FIG. 9 is a conceptual diagram showing an example of an aspect in which a divided screen image is transmitted to the image processing apparatus by the user device included in the image processing system according to the embodiment;

FIG. 10 is a block diagram showing an example of a main function of the image processing apparatus according to an embodiment;

FIG. 11 is a conceptual diagram showing an example of details of processes of the user device communication I/F, an acquisition unit, and a retrieval unit of the image processing apparatus according to the embodiment;

FIG. 12 is a conceptual diagram showing an example of details of processes of a retrieval unit, a processing unit, and an output unit of the image processing apparatus according to the embodiment;

FIG. 13 is a flowchart showing an example of a flow of a processing output process according to the embodiment;

FIG. 14 is a flowchart showing an example of a flow of a processing process included in the processing output process shown in FIG. 13;

FIG. 15 is a perspective view showing an example of an aspect in which an undivided screen is imaged by a physical camera of the user device;

FIG. 16 is a screen view showing an example of a physical camera motion picture screen obtained by imaging an undivided screen with the physical camera of the user device;

FIG. 17 is a screen view showing an example of an aspect in which a physical camera motion picture screen and a frame-advancing motion picture are displayed on a display of the user device;

FIG. 18 is a screen view showing an example of an aspect in which a physical camera motion picture screen and a menu screen are displayed on the display of the user device;

FIG. 19 is a screen view showing an example of an aspect in which a physical camera motion picture screen (a screen on which a bird's-eye view image is displayed) and an object selection screen are displayed on the display of the user device;

FIG. 20 is a conceptual diagram showing an example of an aspect in which a screen number and a television screen incorporation time are transmitted to the image processing apparatus 12 by the user device;

FIG. 21 is a conceptual diagram showing an example of details of processes executed by a CPU of the image processing apparatus in a case where a screen number and a television screen incorporation time are transmitted to an image processing apparatus 12 by the user device;

FIG. 22 is a conceptual diagram showing an example of details of processes executed by the CPU of the image processing apparatus in a case where processing details are changed;

FIG. 23 is a screen view showing an example of an aspect in which a physical camera motion picture screen is displayed as a live view image on the display of the user device;

FIG. 24 is a perspective view showing an example of an aspect in which a plurality of screens are imaged by the physical camera of the user device in a state in which physical camera motion pictures are displayed on respective screens of a plurality of television receivers;

FIG. 25 is a screen view showing an example of an aspect of a plurality of screens displayed on the display of the user device in a case where the plurality of screens shown in FIG. 24 are imaged by and incorporated into the user device;

FIG. 26 is a perspective view showing an example of an aspect in which displays of various types of devices are imaged by the physical camera of the user device; and

FIG. 27 is a block diagram showing an example of an aspect in which a processing output program is installed in a computer of the image processing apparatus from a storage medium in which the processing output program is stored.

### DETAILED DESCRIPTION

An example of an image processing apparatus, an image processing method, and a program according to embodiments of the technique of the present disclosure will be described with reference to the accompanying drawings.

First, the technical terms used in the following description will be described.

CPU stands for “Central Processing Unit”. RAM stands for “Random Access Memory”. SSD stands for “Solid State Drive”. HDD stands for “Hard Disk Drive”. EEPROM stands for “Electrically Erasable and Programmable Read Only Memory”. I/F stands for “Interface”. IC stands for “Integrated Circuit”. ASIC stands for “Application Specific Integrated Circuit”. PLD stands for “Programmable Logic Device”. FPGA stands for “Field-Programmable Gate Array”. SoC stands for “System-on-a-chip”. CMOS stands for “Complementary Metal Oxide Semiconductor”. CCD stands for “Charge Coupled Device”. EL stands for “Electro-Luminescence”. GPU stands for “Graphics Processing Unit”. WAN stands for “Wide Area Network”. LAN stands for “Local Area Network”. 3D stands for “3 Dimension”. USB stands for “Universal Serial Bus”. 5G stands for “5th Generation”. LTE stands for “Long Term Evolution”. WiFi stands for “Wireless Fidelity”. RTC stands for “Real Time Clock”. SNTP stands for “Simple Network Time Protocol”. NTP stands for “Network Time Protocol”. GPS stands for “Global Positioning System”. Exif stands for “Exchangeable image file format for digital still cameras”. ID stands for “Identification”. GNSS stands for “Global Navigation Satellite System”. In the following description, for convenience of description, a CPU is exemplified as an example of a “processor” according to the technique of the present disclosure, but the “processor” according to the technique of the present disclosure may be a combination of a plurality of processing devices such as a CPU and a GPU. In a case where a combination of a CPU and a GPU is applied as an example of the “processor” according to the technique of the present disclosure, the GPU operates under the control of the CPU and executes image processing.

In the following description, the term “match” refers to, in addition to perfect match, a meaning including an error generally allowed in the technical field to which the technique of the present disclosure belongs (a meaning including an error to the extent that the error does not contradict the concept of the technique of the present disclosure). In the following description, the “same imaging time” refers to, in addition to the completely same imaging time, a meaning including an error generally allowed in the technical field to which the technique of the present disclosure belongs (a meaning including an error to the extent that the error does not contradict the concept of the technique of the present disclosure).

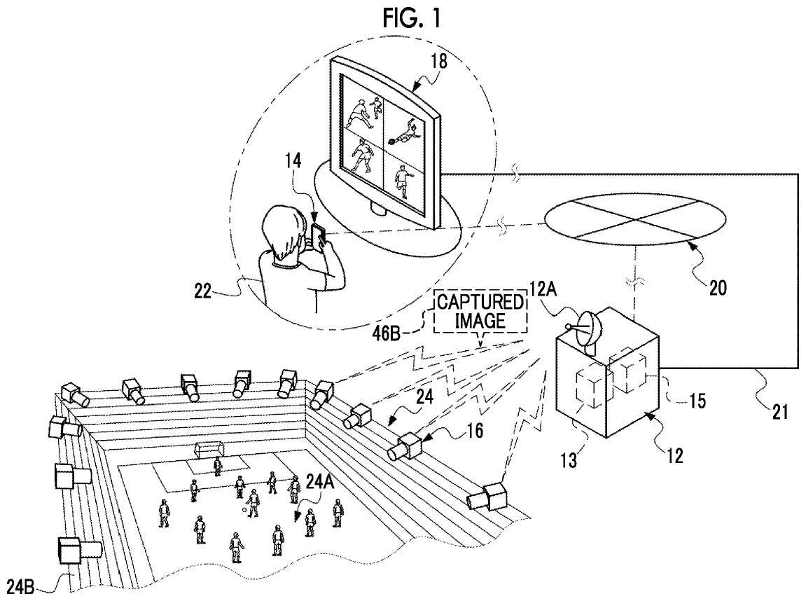

As an example, as shown in FIG. 1, an image processing system 10 includes an image processing apparatus 12, a user device 14, a plurality of physical cameras 16, and a television receiver 18. The user device 14 and the television receiver 18 are used by a user 22.

In the present embodiment, a smartphone is applied as an example of the user device 14. However, the smartphone is only an example, and may be, for example, a personal computer, a tablet terminal, or a portable multifunctional terminal such as a head-mounted display.

In the present embodiment, the image processing apparatus 12 includes a server 13 and a television broadcast device 15. The server 13 is connected to a network 20. The number of servers 13 may be one or a plurality. The server 13 is only an example, and may be, for example, at least one personal computer, or may be a combination of at least one server 13 and at least one personal computer.

The television broadcast device 15 is connected to the television receiver 18 via a cable 21. The television broadcast device 15 transmits television broadcast information indicating video (hereinafter, also referred to as “television video”) and sound for television broadcasting to the television receiver 18 via the cable 21. The television receiver 18 is an example of a “display device” according to the technique of the present disclosure, receives television broadcast information from the television broadcast device 15, and outputs video and sound indicated by the received television broadcast information. Although transmission and reception of the television broadcast information in a wired method are exemplified here, transmission and reception of the television broadcast information in a wireless method may be used.

The network 20 includes, for example, a WAN and/or a LAN. In the example shown in FIG. 1, although not shown, the network 20 includes, for example, a base station. The number of base stations is not limited to one, and there may be a plurality of base stations. The communication standards used in the base station include wireless communication standards such as 5G standard, LTE standard, WiFi (802.11) standard, and Bluetooth (registered trademark) standard. The network 20 establishes communication between the server 13 and the user device 14, and transmits and receives various types of information between the server 13 and the user device 14. The server 13 receives a request from the user device 14 via the network 20, and provides a service according to the request to the requesting user device 14 via the network 20.

In the present embodiment, a wireless communication method is applied as an example of a communication method between the user device 14 and the network 20 and a communication method between the server 13 and the network 20, but this is only an example, a wired communication method may be used.

The physical camera 16 actually exists as an object and is a visually recognizable imaging device. The physical camera 16 is an imaging device having a CMOS image sensor, and has an optical zoom function and/or a digital zoom function. Instead of the CMOS image sensor, another type of image sensor such as a CCD image sensor may be applied. In the present embodiment, the zoom function is provided to a plurality of physical cameras 16, but this is only an example, and the zoom function may be provided to some of the plurality of physical cameras 16, or the zoom function does not have to be provided to the plurality of physical cameras 16.

The plurality of physical cameras 16 are installed in a soccer stadium 24. The plurality of physical cameras 16 have different imaging positions (hereinafter, also simply referred to as “positions”), and an imaging direction (hereinafter, simply referred to as an “orientation”) of each physical camera 16 can be changed. The soccer stadium 24 is provided with spectator seats 24B to surround a soccer field 24A. In the example shown in FIG. 1, each of the plurality of physical cameras 16 is disposed in the spectator seats 24B to surround the soccer field 24A, and a region including the soccer field 24A is imaged as an imaging region. The imaging by the physical camera 16 refers to, for example, imaging at an angle of view including an imaging region. Here, the concept of “imaging region” includes the concept of a region showing a part of the soccer stadium 24 in addition to the concept of the region showing the whole in the soccer stadium 24. The imaging region is changed according to an imaging position, an imaging direction, and an angle of view.

Here, although a form example in which each of the plurality of physical cameras 16 is disposed to surround the soccer field 24A is described, the technique of the present disclosure is not limited to this, and, for example, a plurality of physical cameras 16 may be disposed to surround a specific part in the soccer field 24A. Positions and/or orientations of the plurality of physical cameras 16 can be changed, and it is determined to be generated according to a virtual viewpoint image requested by the user 22 or the like.

Although not shown, at least one physical camera 16 may be installed in an unmanned aerial vehicle (for example, a multi-rotorcraft unmanned aerial vehicle), and a bird's-eye view of a region including the soccer field 24A as an imaging region may be imaged from the sky.

The plurality of physical cameras 16 are wirelessly communicatively connected to the image processing apparatus 12 via an antenna 12A. The plurality of physical cameras 16 transmit captured images 46B obtained by imaging the imaging region to the image processing apparatus 12. The captured images 46B transmitted from the plurality of physical cameras 16 are received by the antenna 12A. The captured images 46B received by the antenna 12A are acquired by the server 13 and the television broadcast device 15.

The television broadcast device 15 transmits a physical camera motion picture acquired from the plurality of physical cameras 16 via the antenna 12A to the television receiver 18 as a television video via the cable 21. The physical camera motion picture is a motion picture configured with a plurality of captured images 46B arranged in time series. The television receiver 18 receives the television video transmitted from the television broadcast device 15 and outputs the received television video.

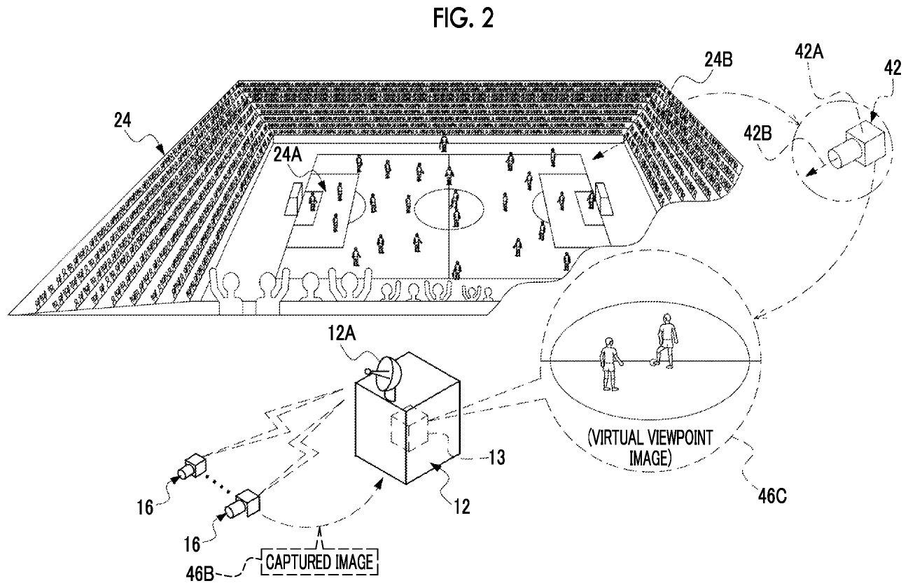

As an example, as shown in FIG. 2, the image processing apparatus 12 acquires the captured image 46B showing an imaging region in a case where the imaging region is observed from each position of the plurality of physical cameras 16, from each of the plurality of physical cameras 16. The captured image 46B is a frame image showing the imaging region in a case where the imaging region is observed from the position of the physical camera 16. That is, the captured image 46B is obtained by each of the plurality of physical cameras 16 imaging the imaging region. In the captured image 46B, a physical camera ID that specifies the physical camera 16 used for imaging and a time point at which an image is captured by the physical camera 16 (hereinafter, also referred to as a “physical camera imaging time”) are added for each frame. In the captured image 46B, physical camera installation position information capable of specifying an installation position (imaging position) of the physical camera 16 used for imaging is also added for each frame.

The server 13 generates an image using 3D polygons by combining a plurality of captured images 46B obtained by the plurality of physical cameras 16 imaging the imaging region. The server 13 generates a virtual viewpoint image 46C showing the imaging region in a case where the imaging region is observed from any position and any direction, frame by frame, on the basis of the image using the generated 3D polygons.

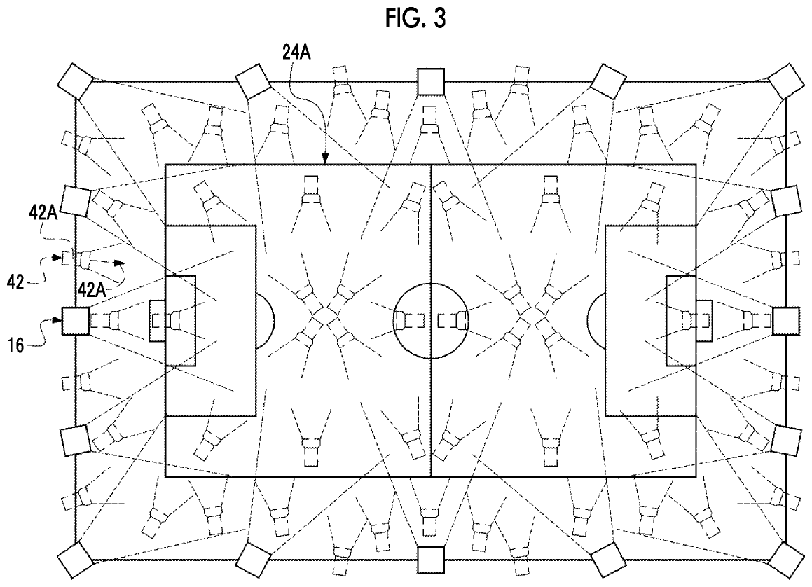

Here, the captured image 46B is an image obtained by being captured by the physical camera 16, whereas the virtual viewpoint image 46C may be considered to be an image obtained by imaging the imaging region with a virtual imaging device, that is, a virtual camera 42 from any position and any direction. The virtual camera 42 is a virtual camera that does not actually exist as an object and is not visually recognized. In the present embodiment, virtual cameras 42 are installed at a plurality of locations in the soccer stadium 24 (refer to FIG. 3). All virtual cameras 42 are installed at different positions from each other. All the virtual cameras 42 are installed at different positions from all the physical cameras 16. That is, all the physical cameras 16 and all the virtual cameras 42 are installed at different positions from each other.

In the virtual viewpoint image 46C, a virtual camera ID that specifies the virtual camera 42 used for imaging and a time point at which an image is captured by the virtual camera 42 (hereinafter, also referred to as a “virtual camera imaging time”) are added for each frame. In the virtual viewpoint image 46C, virtual camera installation position information capable of specifying an installation position (imaging position) of the virtual camera 42 used for imaging is added.

In the following description, for convenience of the description, in a case where it is not necessary to distinguish between the physical camera 16 and the virtual camera 42, the physical camera 16 and the virtual camera 42 will be simply referred to as a “camera”. In the following description, for convenience of the description, in a case where it is not necessary to distinguish between the captured image 46B and the virtual viewpoint image 46C, the captured image 46B and the virtual viewpoint image 46C will be referred to as a “camera image”. In the following description, for convenience of the description, in a case where it is not necessary to distinguish between the physical camera ID and the virtual camera ID, the information will be referred to as “camera specifying information”. In the following description, for convenience of the description, in a case where it is not necessary to distinguish between the physical camera imaging time and the virtual camera imaging time, the physical camera imaging time and the virtual camera imaging time will be referred to as an “imaging time”. In the following description, for convenience of the description, in a case where it is not necessary to distinguish between the physical camera installation position information and the virtual camera installation position information, the information will be referred to as “camera installation position information”. The camera ID, the imaging time, and the camera installation position information are added to each camera image in, for example, the Exif method.

The server 13 stores, for example, camera images for a predetermined time (for example, several hours to several tens of hours). Therefore, for example, the server 13 acquires a camera image at a designated imaging time from a group of camera images for a predetermined time, and processes the acquired camera image.

A position (hereinafter, also referred to as a “virtual camera position”) 42A and an orientation (hereinafter, also referred to as “virtual camera orientation”) 42B of the virtual camera 42 can be changed. An angle of view of the virtual camera 42 can also be changed.

In the present embodiment, the virtual camera position 42A is referred to, but in general, the virtual camera position 42A is also referred to as a viewpoint position. In the present embodiment, the virtual camera orientation 42B is referred to, but in general, the virtual camera orientation 42B is also referred to as a line-of-sight direction. Here, the viewpoint position means, for example, a position of a viewpoint of a virtual person, and the line-of-sight direction means, for example, a direction of a line of sight of a virtual person.

That is, in the present embodiment, the virtual camera is used for convenience of description, but it is not essential to use the virtual camera. “Installing a virtual camera” means determining a viewpoint position, a line-of-sight direction, and/or an angle of view for generating the virtual viewpoint image 46C. Therefore, for example, the present disclosure is not limited to an aspect in which an object such as a virtual camera is installed in an imaging region on a computer, and another method such as numerically designating coordinates and/or a direction of a viewpoint position may be used. “Imaging with a virtual camera” means generating the virtual viewpoint image 46C corresponding to a case where the imaging region is viewed from a position and a direction in which the “virtual camera is installed”.

In the example shown in FIG. 2, as an example of the virtual viewpoint image 46C, a virtual viewpoint image showing an imaging region in a case where the imaging region is observed from the virtual camera position 42A in the spectator seat 24B and the virtual camera orientation 42B is shown. The virtual camera position and virtual camera orientation are not fixed. That is, the virtual camera position and the virtual camera orientation can be changed according to an instruction from the user 22 or the like. For example, the server 13 may set a position of a person designated as a target subject (hereinafter, also referred to as a “target person”) among soccer players, referees, and the like in the soccer field 24A as a virtual camera position, and set a line-of-sight direction of the target person as a virtual camera orientation.

As an example, as shown in FIG. 3, virtual cameras 42 are installed at a plurality of locations in the soccer field 24A and at a plurality of locations around the soccer field 24A. The installation aspect of the virtual camera 42 shown in FIG. 3 is only an example. For example, there may be a configuration in which the virtual camera 42 is not installed in the soccer field 24A and the virtual camera 42 is installed only around the soccer field 24A, or the virtual camera 42 is not installed around the soccer field 24A and the virtual camera 42 is installed only in the soccer field 24A. The number of virtual cameras 42 installed may be larger or smaller than the example shown in FIG. 3. The virtual camera position 42A and the virtual camera orientation 42B of each of the virtual cameras 42 can also be changed.

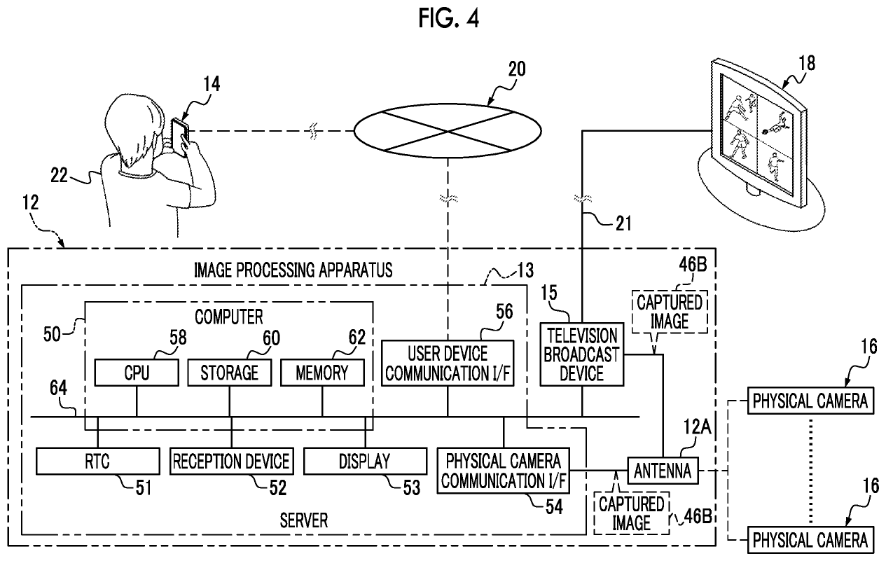

As an example, as shown in FIG. 4, the server 13 includes a computer 50, an RTC 51, a reception device 52, a display 53, a physical camera communication I/F 54, and a user device communication I/F 56. The computer 50 includes a CPU 58, a storage 60, and a memory 62. The CPU 58 is an example of a “processor” according to the technique of the present disclosure. The memory 62 is an example of a “memory” according to the technique of the present disclosure. The computer 50 is an example of a “computer” according to the technique of the present disclosure.

The CPU 58, the storage 60, and the memory 62 are connected via a bus 64. In the example shown in FIG. 4, one bus is shown as the bus 64 for convenience of illustration, but a plurality of buses may be used. The bus 64 may include a serial bus or a parallel bus configured with a data bus, an address bus, a control bus, and the like.

The CPU 58 controls the entire image processing apparatus 12. The storage 60 stores various parameters and various programs. The storage 60 is a non-volatile storage device.

Here, an SSD and an HDD are applied as an example of the storage 60. However, this is only an example, and may be an SSD, an HDD, or an EEPROM, or the like. The memory 62 is a storage device. Various types of is temporarily stored in the memory 62. The memory 62 is used as a work memory by the CPU 58. Here, a RAM is applied as an example of the memory 62. However, this is only an example, and other types of storage devices may be used.

The RTC 51 receives drive power from a power supply system disconnected from a power supply system for the computer 50, and continues to count the current time (for example, year, month, day, hour, minute, second) even in a case where the computer 50 is shut down. The RTC 51 outputs the current time to the CPU 58 each time the current time is updated. The CPU 58 uses the current time input from the RTC 51 as an imaging time. Here, a form example in which the CPU 58 acquires the current time from the RTC 51 is described, but the technique of the present disclosure is not limited to this. For example, the CPU 58 may acquire the current time provided from an external device (not shown) via the network 20 (for example, by using an SNTP and/or an NTP), or may acquire the current time from a GNSS device (for example, a GPS device) built in or connected to the computer 50.

The reception device 52 receives an instruction from a user or the like of the image processing apparatus 12. Examples of the reception device 52 include a touch panel, hard keys, and a mouse. The reception device 52 is connected to the bus 64 or the like, and the instruction received by the reception device 52 is acquired by the CPU 58.

The display 53 is connected to the bus 64 and displays various types of information under the control of the CPU 58. An example of the display 53 is a liquid crystal display. In addition to the liquid crystal display, another type of display such as an EL display (for example, an organic EL display or an inorganic EL display) may be employed as the display 53.

The physical camera communication I/F 54 is connected to the antenna 12A. The physical camera communication I/F 54 is realized by, for example, a device having an FPGA. The physical camera communication I/F 54 is connected to the bus 64 and controls the exchange of various types of information between the CPU 58 and the plurality of physical cameras 16. For example, the physical camera communication I/F 54 controls the plurality of physical cameras 16 according to a request from the CPU 58. The physical camera communication I/F 54 acquires the captured image 46B (refer to FIG. 2) obtained by being captured by each of the plurality of physical cameras 16, and outputs the acquired captured image 46B to the CPU 58. Here, as an example of the physical camera communication I/F 54, a wireless communication I/F such as a high-speed wireless LAN is used. However, this is only an example, and a wired communication I/F may be used.

The user device communication I/F 56 is wirelessly communicatively connected to the network 20. The user device communication I/F 56 is realized by, for example, a device having an FPGA. The user device communication I/F 56 is connected to the bus 64. The user device communication I/F 56 controls the exchange of various types of information between the CPU 58 and the user device 14 in a wireless communication method via the network 20.

At least one of the physical camera communication I/F 54 or the user device communication I/F 56 may be configured with a fixed circuit instead of the FPGA. At least one of the physical camera communication I/F 54 or the user device communication I/F 56 may be a circuit configured with an ASIC, an FPGA, and/or a PLD.

The television broadcast device 15 is connected to the bus 64, and the CPU 58 can ascertain a state of the television broadcast device 15 by exchanging various types of information with the television broadcast device 15 via the bus 64. For example, the CPU 58 can specify the captured image 46B transmitted to the television receiver 18 from the television broadcast device 15.

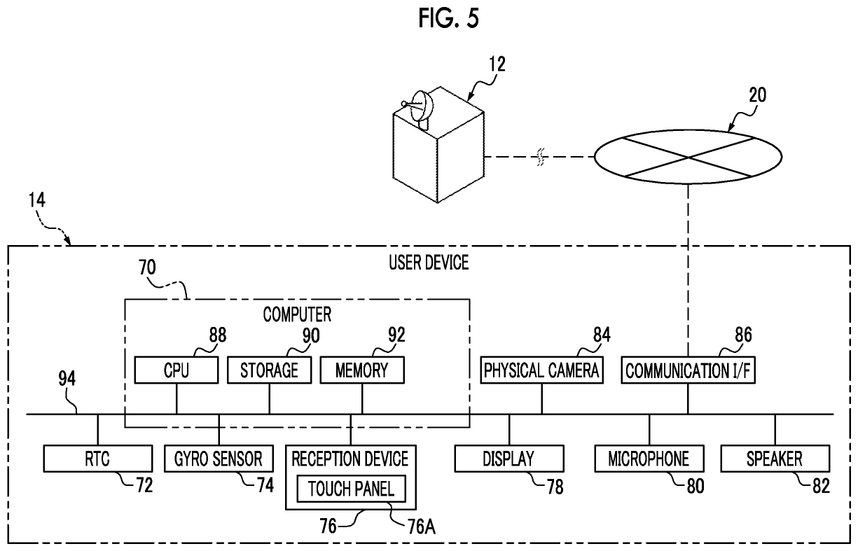

As an example, as shown in FIG. 5, the user device 14 includes a computer 70, an RTC 72, a gyro sensor 74, a reception device 76, a display 78, a microphone 80, a speaker 82, a physical camera 84, and a communication I/F 86. The computer 70 includes a CPU 88, a storage 90, and a memory 92, and the CPU 88, the storage 90, and the memory 92 are connected via a bus 94. In the example shown in FIG. 5, one bus is shown as the bus 94 for convenience of illustration, but the bus 94 may be configured with a serial bus, or may be configured to include a data bus, an address bus, a control bus, and the like.

The CPU 88 controls the entire user device 14. The storage 90 stores various parameters and various programs. The storage 90 is a non-volatile storage device. Here, an EEPROM is applied as an example of the storage 90. However, this is only an example, and an SSD, an HDD, or the like may be used. Various types of information are temporarily stored in the memory 92, and the memory 92 is used as a work memory by the CPU 88. Here, a RAM is applied as an example of the memory 92. However, this is only an example, and other types of storage devices may be used.

The RTC 72 receives supply of drive power from a power supply system disconnected from a power supply system for the computer 70, and continues to tick the current time (for example, year, month, day, hour, minute, and second) even in state in which the computer 70 is shut down. The RTC 72 outputs the current time to the CPU 88 every time the current time is updated. In a case where various types of information are transmitted to the image processing apparatus 12, the CPU 88 can add the current time input from the RTC 72 to the various types of information transmitted to the image processing apparatus 12. Here, a form example in which the CPU 88 acquires the current time from the RTC 72 is described, but the technique of the present disclosure is not limited to this. For example, the CPU 88 may acquire the current time provided from an external device (not shown) via the network 20 (for example, by using an SNTP and/or an NTP), or may acquire the current time from a GNSS device (for example, a GPS device) built in or connected to the computer 70.

The gyro sensor 74 measures an angle about the yaw axis of the user device 14 (hereinafter, also referred to as a “yaw angle”), an angle about the roll axis of the user device 14 (hereinafter, also referred to as a “roll angle”), and an angle about the pitch axis of the user device 14 (hereinafter, also referred to as a “pitch angle”). The gyro sensor 74 is connected to the bus 94, and angle information indicating the yaw angle, the roll angle, and the pitch angle measured by the gyro sensor 74 is acquired by the CPU 88 via the bus 94 or the like.

The reception device 76 receives an instruction from the user 22 (refer to FIGS. 1 and 2). Examples of the reception device 76 include a touch panel 76A and a hard key. The reception device 76 is connected to the bus 94, and the instruction received by the reception device 76 is acquired by the CPU 88.

The display 78 is an example of a “display” according to the technique of the present disclosure. The display 78 is connected to the bus 94 and displays various types of information under the control of the CPU 88. An example of the display 78 is a liquid crystal display. In addition to the liquid crystal display, another type of display such as an EL display (for example, an organic EL display or an inorganic EL display) may be employed as the display 78.

The user device 14 includes a touch panel display, and the touch panel display is implemented by the touch panel 76A and the display 78. That is, the touch panel display is formed by overlapping the touch panel 76A on a display region of the display 78, or by incorporating a touch panel function (“in-cell” type) inside the display 78. The “in-cell” type touch panel display is only an example, and an “out-cell” type or “on-cell” type touch panel display may be used.

The microphone 80 converts collected sound into an electrical signal. The microphone 80 is connected to the bus 94. The electrical signal obtained by converting the sound collected by the microphone 80 is acquired by the CPU 88 via the bus 94.

The speaker 82 converts an electrical signal into sound. The speaker 82 is connected to the bus 94. The speaker 82 receives the electrical signal output from the CPU 88 via the bus 94, converts the received electrical signal into sound, and outputs the sound obtained by converting the electrical signal to the outside of the user device 14.

The physical camera 84 acquires an image showing the subject by imaging the subject. The physical camera 84 is connected to the bus 94. The image obtained by imaging the subject in the physical camera 84 is acquired by the CPU 88 via the bus 94. For example, in a case where the user 22 uses the physical camera 84 to image the inside of the soccer field 24A, an image obtained by being captured by the physical camera 84 may also be used together with the captured image 46B to generate the virtual viewpoint image 46C.

The communication I/F 86 is wirelessly communicatively connected to the network 20. The communication I/F 86 is realized by, for example, a device configured with circuits (for example, an ASIC, an FPGA, and/or a PLD). The communication I/F 86 is connected to the bus 94. The communication I/F 86 controls the exchange of various types of information between the CPU 88 and an external device in a wireless communication method via the network 20. Here, examples of the “external device” include the image processing apparatus 12.

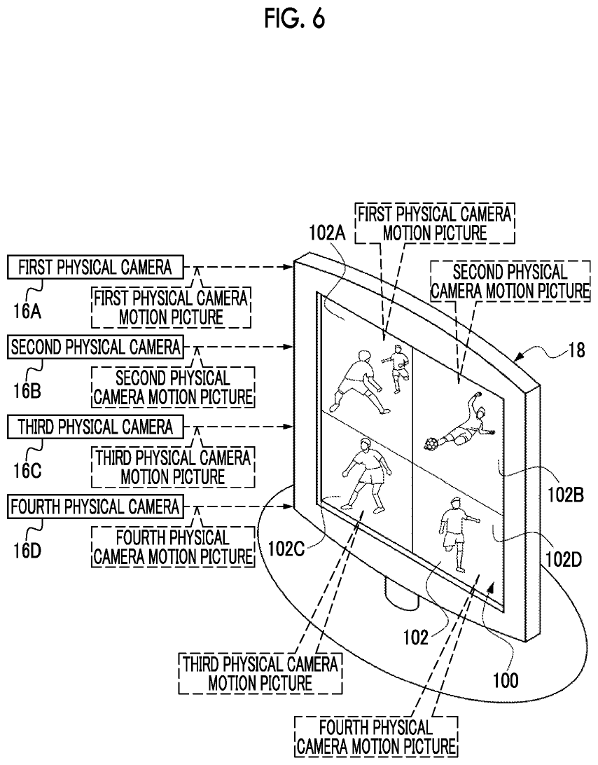

As an example, as shown in FIG. 6, four types of physical camera motion pictures obtained by capturing images of imaging regions (here, as an example, different regions in the soccer field 24A) with four physical cameras 16 out of a plurality of physical cameras 16 are received by the television receiver 18 as television videos. In the example shown in FIG. 6, as the four physical cameras 16, a first physical camera 16A, a second physical camera 16B, a third physical camera 16C, and a fourth physical camera 16D are used. Although the four physical cameras 16 are exemplified here for convenience of description, the technique of the present disclosure is not limited to this, and the number of physical cameras 16 may be any number.

The physical camera motion pictures are roughly classified as first to fourth physical camera motion pictures. The first physical camera 16A transmits a first physical camera motion picture as a television video to the television receiver 18. The second physical camera 16B transmits a second physical camera motion picture as a television video to the television receiver 18. The third physical camera 16C transmits a third physical camera motion picture as a television video to the television receiver 18. The fourth physical camera 16D transmits a fourth physical camera motion picture as a television video to the television receiver 18.

The television receiver 18 includes a display 100. The display 100 has a screen 102, and a physical camera motion picture is displayed as a television video on the screen 102. Here, the screen 102 on which the physical camera motion picture is displayed as a television video is an example of “another screen” according to the technique of the present disclosure. The physical camera motion picture displayed on the screen 102 is an example of an “imaging region image” according to the technique of the present disclosure.

The screen 102 has a plurality of divided screens. In the example shown in FIG. 6, the screen 102 is divided into four screens, and the screen 102 has a first divided screen 102A, a second divided screen 102B, a third divided screen 102C, and a fourth divided screen 102D. In the following description, for convenience of the description, in a case where it is not necessary to distinguish between the first divided screen 102A, the second divided screen 102B, the third divided screen 102C, and the fourth divided screen 102D, the screens will be referred to as a “television side divided screen”.

The first physical camera motion picture is displayed on the first divided screen 102A. The second physical camera motion picture is displayed on the second divided screen 102B. The third physical camera motion picture is displayed on the third divided screen 102C. The fourth physical camera motion picture is displayed on the fourth divided screen 102D. That is, on the first divided screen 102A, the second divided screen 102B, the third divided screen 102C, and the fourth divided screen 102D, four images obtained by capturing images of imaging regions in different imaging methods are displayed individually for the respective television side divided screens. Here, the imaging method refers to, for example, an imaging position, an imaging direction, and/or an angle of view.

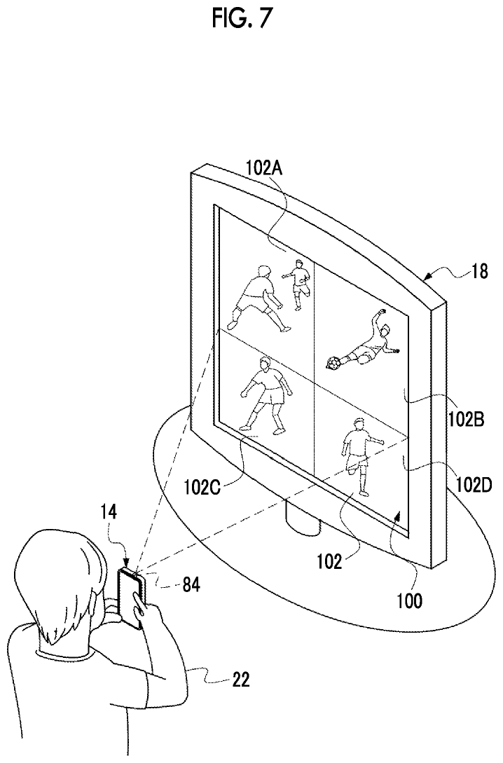

In the image processing system 10, as shown in FIG. 7 as an example, the screen 102 is imaged by the physical camera 84 of the user device 14. The imaging performed here is an imaging for a still image for one frame. However, this is only an example, and imaging for a motion picture may be performed.

As described above, in a case where the screen 102 is imaged by the physical camera 84, an image showing the screen 102 on which the physical camera motion pictures are displayed is incorporated into the user device 14 as a still image for one frame. The display 78 of the user device 14 displays a physical camera motion picture screen 104 showing the screen 102 incorporated as an image into the user device 14. The physical camera motion picture screen 104 is a still image for one frame showing the screen 102. However, this is only an example, and the physical camera motion picture screen 104 may be a motion picture obtained by performing imaging for a motion picture with the physical camera 84 of the user device 14 with the screen 102 as a subject. The physical camera motion picture screen 104 is an example of an “imaging region image screen” according to the technique of the present disclosure.

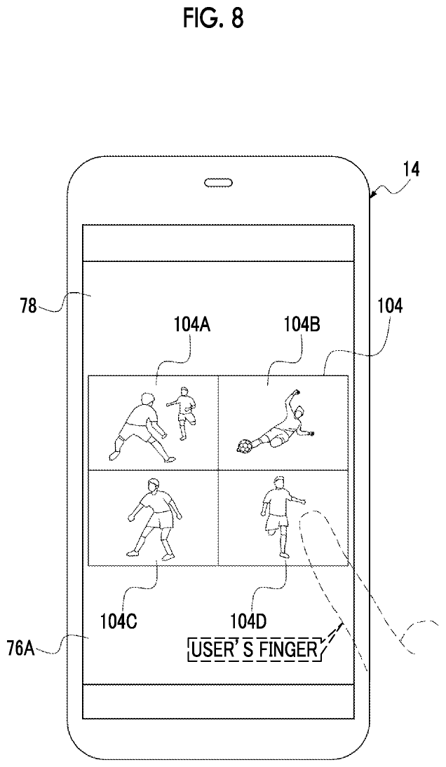

The physical camera motion picture screen 104 has a plurality of divided screens. In the example shown in FIG. 8, examples of the plurality of divided screens include a first divided screen 104A, a second divided screen 104B, a third divided screen 104C, and a fourth divided screen 104D. The first divided screen 104A, the second divided screen 104B, the third divided screen 104C, and the fourth divided screen 104D are screens obtained by dividing the physical camera motion picture screen 104 into four regions. In the following description, for convenience of the description, in a case where it is not necessary to distinguish between the first divided screen 104A, the second divided screen 104B, the third divided screen 104C, and the fourth divided screen 104D, the screens will be referred to as a “user device side divided screen”.

On the first divided screen 104A, the second divided screen 104B, the third divided screen 104C, and the fourth divided screen 104D, a plurality of unique images obtained by being captured in imaging methods in which imaging regions are different are displayed individually for the respective user device side divided screens. The four unique images refer to an image corresponding to the captured image 46B (for example, the captured image 46B included in the first physical camera motion picture) displayed on the first divided screen 102A, an image corresponding to the captured image 46B (for example, the captured image 46B included in the second physical camera motion picture) displayed on the second divided screen 102B, an image corresponding to the captured image 46B (for example, the captured image 46B included in the third physical camera motion picture) displayed on the third divided screen 102C, and an image corresponding to the captured image 46B (for example, the captured image 46B included in the fourth physical camera motion picture) displayed on the fourth divided screen 102D.

The first divided screen 104A is a screen corresponding to the first divided screen 102A. The screen corresponding to the first divided screen 102A refers to, for example, an image obtained by imaging the first divided screen 102A. Therefore, an image corresponding to the captured image 46B displayed on the first divided screen 102A is displayed on the first divided screen 104A.

The second divided screen 104B is a screen corresponding to the second divided screen 102B. The screen corresponding to the second divided screen 102B refers to, for example, an image obtained by imaging the second divided screen 102B. Therefore, an image corresponding to the captured image 46B displayed on the second divided screen 102B is displayed on the second divided screen 104B.

The third divided screen 104C is a screen corresponding to the third divided screen 102C. The screen corresponding to the third divided screen 102C refers to, for example, an image obtained by imaging the third divided screen 102C. Therefore, an image corresponding to the captured image 46B displayed on the third divided screen 102C is displayed on the third divided screen 104C.

The fourth divided screen 104D is a screen corresponding to the fourth divided screen 102D. The screen corresponding to the fourth divided screen 102D refers to, for example, an image obtained by imaging the fourth divided screen 102D. Therefore, an image corresponding to the captured image 46B displayed on the fourth divided screen 102D is displayed on the fourth divided screen 104D.

The arrangement of the first divided screen 104A, the second divided screen 104B, the third divided screen 104C, and the fourth divided screen 104D in the display 78 is same as the arrangement of the first divided screen 102A, the second divided screen 102B, the third divided screen 102C, and the fourth divided image 102D in the display 100 shown in FIG. 7.

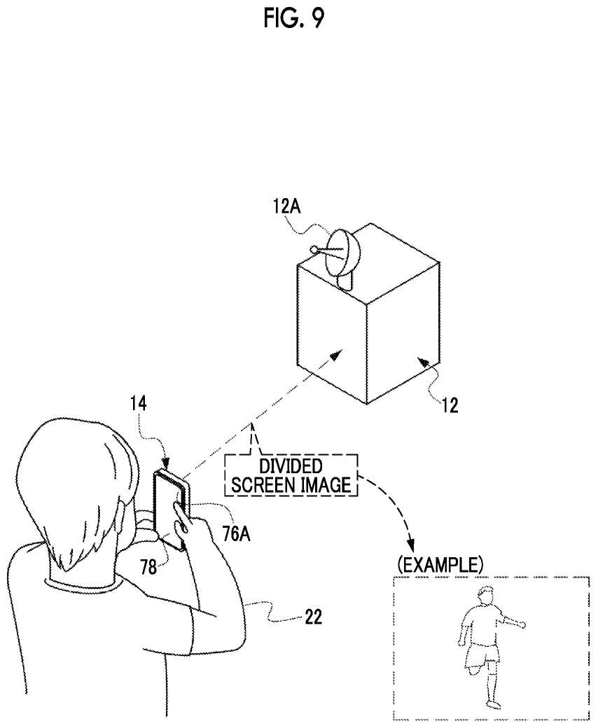

In a state in which the physical camera motion picture screen 104 is displayed on the display 78, the user 22 selects one of the user device side divided screens via the touch panel 76A, and thus the selected user device side divided screen is designated as a screen provided to the image processing apparatus 12. In a case where the user device side divided screen is designated as described above, as shown in FIG. 9 as an example, a divided screen image showing the designated user device side divided screen is transmitted to the image processing apparatus 12 by the user device 14.

In the examples shown in FIGS. 8 and 9, the fourth divided screen 104D is designated by the user 22, and the divided screen image showing the fourth divided screen 104D is transmitted to the image processing apparatus 12 by the user device 14. The divided screen image transmitted by the user device 14 as described above is received by the user device communication I/F 56 (refer to FIG. 4) of the image processing apparatus 12. The divided screen designated by the user 22 is an example of a “specific region” according to the technique of the present disclosure, and the divided screen image is an example of “specific region information” according to the technique of the present disclosure.

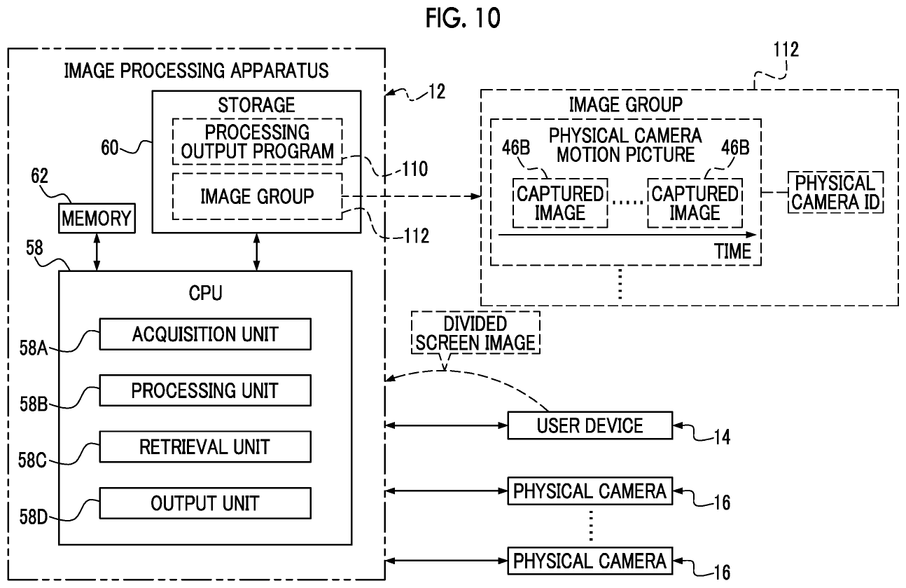

As an example, as shown in FIG. 10, a processing output program 110 and an image group 112 are stored in the storage 60 of the image processing apparatus 12. The image group 112 includes a plurality of physical camera motion pictures obtained by capturing images of imaging regions with a plurality of physical cameras 16 (for example, all the physical cameras 16 installed in the soccer stadium 24) including the first physical camera 16A, the second physical camera 16B, the third physical camera 16C, and the fourth physical camera 16D. Each of the plurality of physical camera motion pictures is associated with a physical camera ID that can specify the physical camera 16 used for capturing the physical camera motion picture.

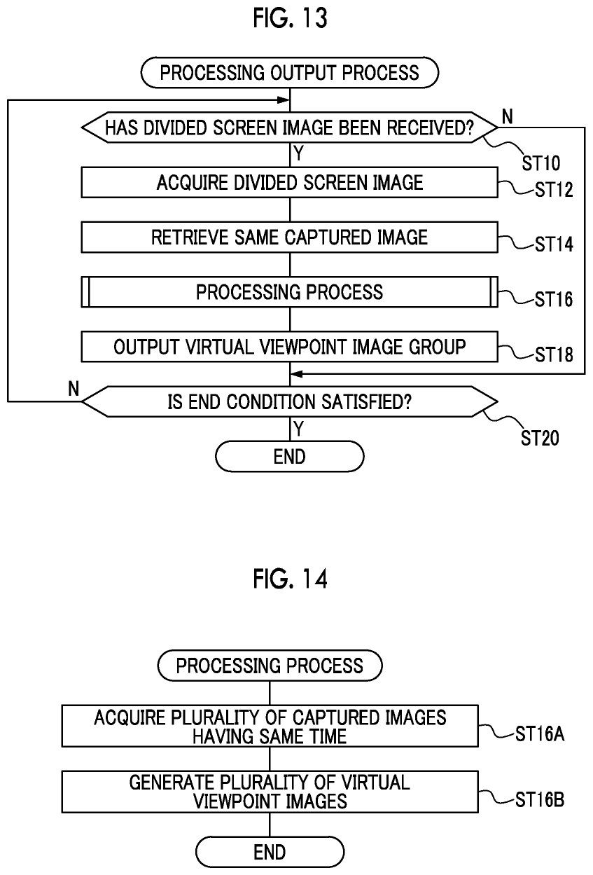

The CPU 58 executes a processing output process (refer to FIG. 13) that will be described later according to the processing output program 110 stored in the storage 60.

The CPU 58 reads the processing output program 110 from the storage 60 and executes the processing output program 110 on the memory 62 to operate as an acquisition unit 58A, a processing unit 58B, a retrieval unit 58C, and an output unit 58D.

The acquisition unit 58A acquires a divided screen image showing a user device side divided screen designated on the physical camera motion picture screen 104. The processing unit 58B processes the captured image 46B corresponding to the divided screen image acquired by the acquisition unit 58A among the plurality of captured images 46B configuring the plurality of physical camera motion pictures in the image group 112. The output unit 58D outputs a processed image obtained by processing the captured image 46B in the processing unit 58B.

Here, the image group 112 is an example of “a plurality of images obtained by imaging an imaging region” according to the technique of the present disclosure. The captured image 46B corresponding to the divided screen image acquired by the acquisition unit 58A is an example of an “image corresponding to a specific region indicated by specific region information” according to the technique of the present disclosure. The processed image is a example of a “specific region processed image” according to the technique of the present disclosure.

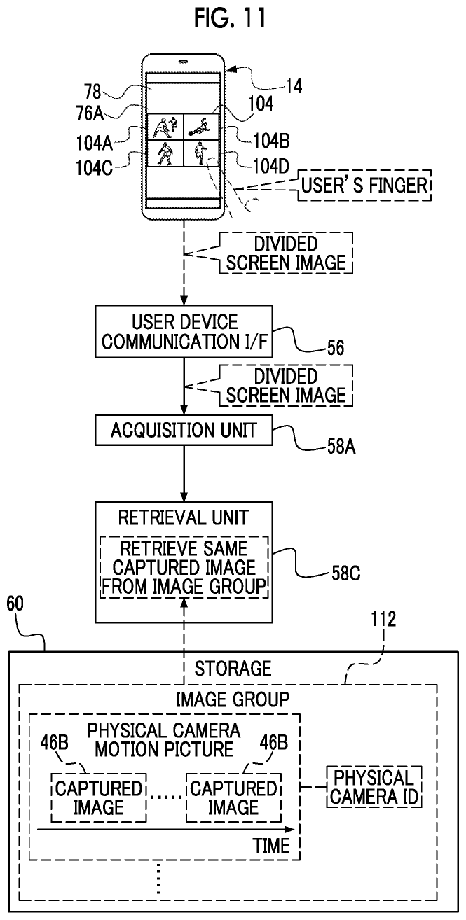

As an example, as shown in FIG. 11, the divided screen image transmitted from the user device 14 to the image processing apparatus 12 is received by the user device communication I/F 56. The acquisition unit 58A acquires the divided screen image received by the user device communication I/F 56. The retrieval unit 58C retrieves the captured image 46B that matches the divided screen image acquired by the acquisition unit 58A from the image group 112 in the storage 60. Here, the captured image 46B that matches the divided screen image refers to, for example, the captured image 46B that has the highest degree of matching with the divided screen image among all the captured images 46B included in the image group 112. In the following description, for convenience of the description, the captured image 46B that matches the divided screen image will also be referred to as the “same captured image”.

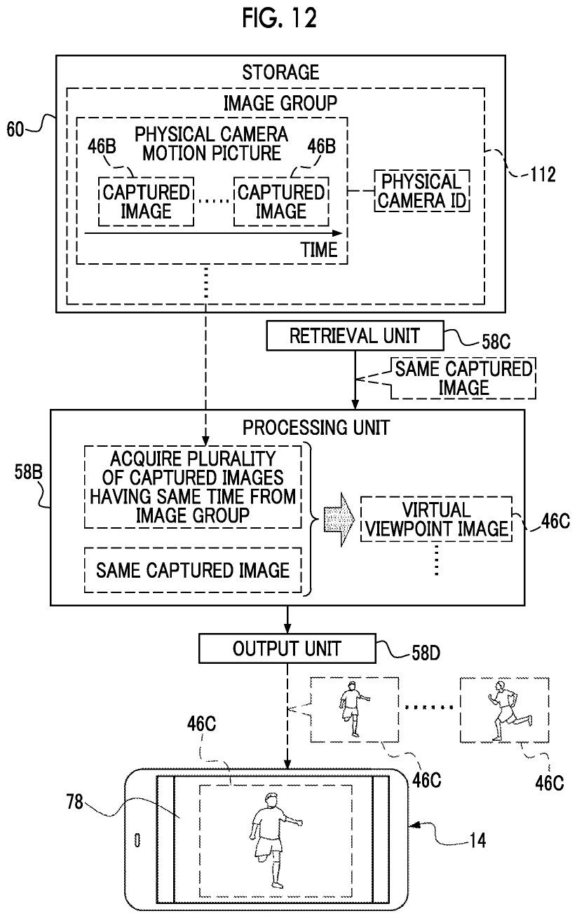

As an example, as shown in FIG. 12, the processing unit 58B acquires the same captured image from the retrieval unit 58C. The processing unit 58B acquires a plurality of captured images 46B (hereinafter, also referred to as “the same time image group”) which are given the same imaging time as that of the same captured image acquired from the retrieval unit 58C from the plurality of physical camera motion pictures in the image group 112. The processing unit 46 generates a plurality of virtual viewpoint images 46C by using the same captured image acquired from the retrieval unit 58C and the same time image group.

Here, the same captured image is used to generate the virtual viewpoint image 46C, and at least one captured image 46B of the same time image group is also used. There are a plurality of patterns in which at least one captured image 46B selected from the same time image group is combined with the same captured image. The processing unit 46 generates the virtual viewpoint image 46C for each combination pattern. For example, in a case where the same time image group includes first to third captured images, the processing unit 46 generates seven types of virtual viewpoint images 46C according to a combination of the same captured image and the first captured image, a combination of the same captured image and the second captured image, a combination of the same captured image and the third captured image, a combination of the same captured image, the first captured image, and the second captured image, a combination of the same captured image, the first captured image, and the third captured image, a combination of the same captured image, the second captured image, and the third captured image, and a combination of the same captured image and the first to third captured images.

The output unit 58D outputs the plurality of virtual viewpoint images 46C generated by the processing unit 58B to the user device 14. Consequently, at least one of the plurality of virtual viewpoint images 46C is displayed on the display 78 of the user device 14. In the present embodiment, the virtual viewpoint image 46C showing an aspect of observing the imaging region at the same viewpoint position, line-of-sight direction, and angle of view as those of the physical camera 16 used for imaging for obtaining the virtual viewpoint image 46C corresponding to the selected user device side divided screen, that is, the physical camera motion picture is displayed on the display 78 of the user device 14.

The plurality of virtual viewpoint images 46C may be selectively displayed on the display 78 in units of one frame in response to an instruction given to the user device 14 via the touch panel 76A by the user 22. All of the virtual viewpoint images 46C may be displayed to be selectable in a list in a thumbnail format.

Next, an operation of the image processing system 10 will be described with reference to FIGS. 13 and 14.

FIG. 13 shows an example of a flow of a processing output process executed by the CPU 58 according to the processing output program 110. In the processing output process shown in FIG. 13, first, in step ST10, the acquisition unit 58A determines whether or not a divided screen image has been received by the user device communication I/F 56. In a case where the divided screen image has not been received by the user device communication I/F 56 in step ST10, a determination result is negative, and the processing output process proceeds to step ST20. In a case where the divided screen image has been received by the user device communication I/F 56 in step ST10, a determination result is positive, and the processing output process proceeds to step ST12.

In step ST12, the acquisition unit 58A acquires the divided screen image received by the user device communication I/F 56, and then the processing output process proceeds to step ST14.

In step ST14, the retrieval unit 58C retrieves the captured image 46B that matches the divided screen image acquired in step ST12, that is, the same captured image from the image group 112 in the storage 60, and then the processing output process proceeds to step ST16.

In step ST16, the processing unit 58B executes a processing process shown in FIG. 14 as an example, and then the processing output process proceeds to step ST18.

In the processing process shown in FIG. 14, first, in step ST16A, the processing unit 58B acquires a plurality of captured images 46B to which the same imaging time as the imaging time added to the same captured image acquired from retrieval unit 58C is added, that is, the same time image group from a plurality of physical camera motion pictures in the image group 112, and then the processing output process proceeds to step ST16B.

In step ST16B, the processing unit 58B generates a plurality of virtual viewpoint images 46C on the basis of the same captured image retrieved in step ST14 and the same time image group acquired in step ST16A, and then processing process is ended.

In step ST18 shown in FIG. 13, the output unit 58D outputs the plurality of virtual viewpoint images 46C generated in step ST16B to the user device 14. Consequently, at least one of the plurality of virtual viewpoint images 46C is displayed on the display 78 of the user device 14. After the process in step ST18 is executed, the processing output process proceeds to step ST20.

In step ST20, the output unit 58D determines whether or not a condition for ending the processing output process (hereinafter, also referred to as a “processing output process end condition”) is satisfied. As an example of the processing output process end condition, there is a condition that the image processing apparatus 12 is instructed to end the processing output process. The instruction for ending the processing output process is received by, for example, the reception device 52 or 76. In a case where the processing output process end condition is not satisfied in step ST20, a determination result is negative, and the processing output process proceeds to step ST10. In a case where the processing output process end condition is satisfied in step ST20, a determination result is positive, and the processing output process is ended.

As described above, in the image processing system 10, in a case where the divided screen image showing the user device side divided screen designated by the user 22 is acquired by the acquisition unit 58A, the same captured image corresponding to the divided screen image acquired by the acquisition unit 58A is processed by the processing unit 58B to generate the virtual viewpoint image 46C. Therefore, according to the present configuration, among the plurality of captured images 46B included in the physical camera motion picture, the virtual viewpoint image 46C obtained by processing the captured image 46B designated by the user 22 selecting the user device side divided screen can be viewed by the user 22.

Here, a form example in which any one of the plurality of captured images 46B is designated by the user 22 is described, but the technique of the present disclosure is not limited to this, and a person (for example, a soccer commentator) other than the user 22 may designates the captured image 46B that is a processing target.

The physical camera motion picture may be a live broadcast video. In this case, among the plurality of captured images 46B included in the live broadcast video, the user 22 can view the virtual viewpoint image 46C obtained by processing the captured image 46B designated by the user 22 selecting the user device side divided screen.

The physical camera motion picture may be an image including a live broadcast video. An example of the image including a live broadcast video is a video including a live broadcast video and a replay video.

In the image processing system 10, the physical camera 84 of the user device 14 images the screen 102 of the television receiver 18, and thus the physical camera motion picture screen 104 is displayed on the display 78 of the user device 14. Therefore, according to the present configuration, even in a situation in which a television video is not directly provided to the user device 14 from the television broadcast device 15, the user 22 can designate the captured image 46B that is a processing target from the physical camera motion picture as a television video.

In the image processing system 10, the captured image 46B that is a processing target is designated by the user 22 selecting one user device side divided screen from among a plurality of user device side divided screens included in the physical camera motion picture screen 104. Therefore, according to the present configuration, the user 22 can designate the captured image 46B that is a processing target for each user device side divided screen.

In the image processing system 10, on the first divided screen 104A, the second divided screen 104B, the third divided screen 104C, and the fourth divided screen 104D, a plurality of unique images obtained by capturing images of imaging regions in different imaging methods are displayed individually for the respective user device side divided screens. Therefore, according to the present configuration, the user 22 can select any of the first divided screen 104A, the second divided screen 104B, the third divided screen 104C, and the fourth divided screen 104D as a user device side divided screen, and can thus designate any one of the plurality of captured images 46B obtained by being captured in different imaging methods as the captured image 46B.

In the image processing system 10, the virtual viewpoint image 46C generated by the processing unit 58B is output to the user device 14 by the output unit 58D, and thus the virtual viewpoint image 46C is displayed on the display 78 of the user device 14. Therefore, according to the present configuration, among the plurality of captured images 46B included in the physical camera motion picture, the virtual viewpoint image 46C obtained by processing the captured image 46B designated by the user 22 selecting the user device side divided screen can be viewed by the user 22 via the display 78 of the user device 14.

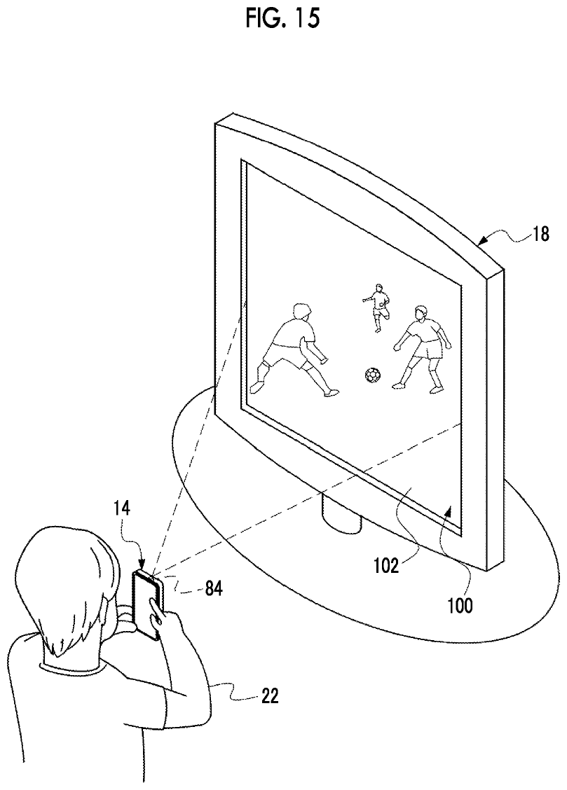

In the above embodiment, a form example has been described in which a plurality of physical camera motion pictures obtained by being captured in different imaging methods are displayed in parallel on the display 100 of the television receiver 18, so that the entire screen 102 is contained in one frame and the screen 102 is imaged by the physical camera 84 of the user device 14, but the technique of the present disclosure is not limited to this. For example, as shown in FIG. 15, only the physical camera motion picture obtained by being imaged by any one of the plurality of physical cameras 16 may be displayed on the screen 102, and the entire screen 102 may be contained in one frame by the physical camera 84 of the user device 14.

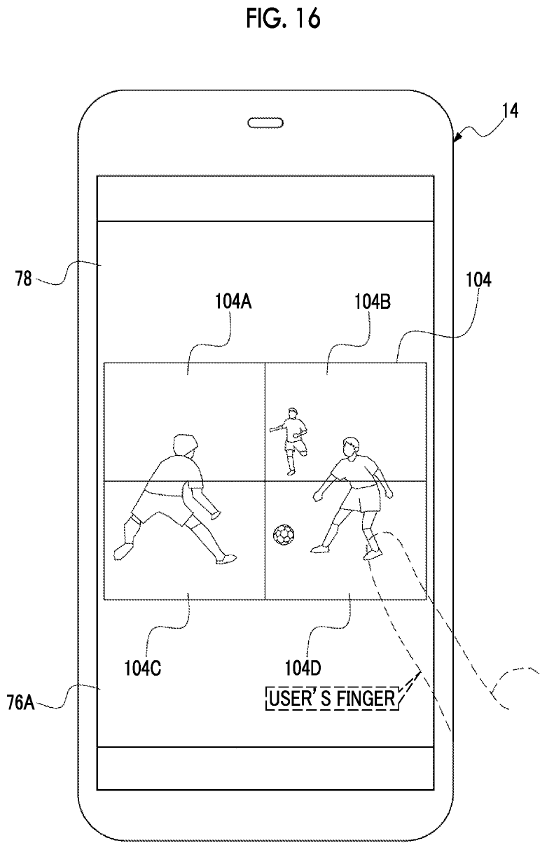

In this case, for example, as shown in FIG. 16, the physical camera motion picture screen 104 is divided into a plurality of regions and displayed. In the example shown in FIG. 16, as the physical camera motion picture screen 104, a screen showing the captured image 46B for one frame is displayed on the display 78. In the example shown in FIG. 16, an aspect in which the physical camera motion picture screen 104 is divided into four screens such as the first divided screen 104A, the second divided screen 104B, the third divided screen 104C, and the fourth divided screen 104D is shown. Also in this case, similarly to the above embodiment, the user device side divided screen is selected by the user 22 among the first divided screen 104A, the second divided screen 104B, the third divided screen 104C, and the fourth divided screen 104D. The divided screen image showing the user device side divided screen selected by the user 22 is transmitted to the image processing apparatus 12 by the user device 14. In this case, a part of the captured image 46B for one frame is set as a processing target by the processing unit 58B, and the processing output process is executed in the same manner as in the above embodiment.

Consequently, it is possible to obtain an image (for example, the virtual viewpoint image 46C) in which a part of the captured image 46B for one frame is processed. The user 22 selects any of the first divided screen 104A, the second divided screen 104B, the third divided screen 104C, and the fourth divided screen 104D, and can thus designate a part of the captured image 46B for one frame as an image that is a processing target.

In the example shown in FIG. 16, the physical camera motion picture screen 104 is divided into a plurality of regions and displayed, but the technique of the present disclosure is not limited to this, and the physical camera motion picture screen 104 may be displayed on the display 78 of the user device 14 as a single screen without being divided.

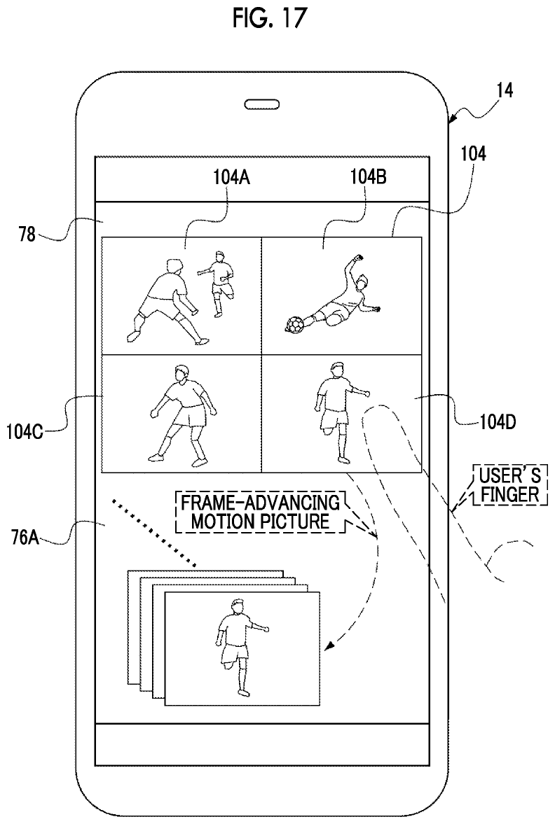

In the above embodiment, a still image for one frame is displayed on the physical camera motion picture screen 104, but the technique of the present disclosure is not limited to this. For example, as shown in FIG. 17, a frame-advancing motion picture may be displayed on the display 78. In this case, for example, the screen 102 on which the physical camera motion picture is displayed is set as a subject, the physical camera 84 of the user device 14 captures the motion picture, and the motion picture showing the screen 102 is incorporated into the user device 14.

On the display 78 of the user device 14, for example, a still image (for example, a still image of the first frame) for one frame of the motion picture obtained by imaging the screen 102 with the physical camera 84 of the user device 14 is divided and displayed on the first divided screen 104A, the second divided screen 104B, the third divided screen 104C, and the fourth divided screen 104D.

Here, the user 22 selects any of the first divided screen 104A, the second divided screen 104B, the third divided screen 104C, and the fourth divided screen 104D via the touch panel 76A. In a case where any of the user device side divided screens is selected by the user 22 as described above, a frame-advancing motion picture selected by the user 22 related to the user device side divided screen is displayed in a display region of the display 78, which is different from the physical camera motion picture screen 104. In a case where any frame included in the frame-advancing motion picture is selected by the user 22 via the touch panel 76A, a divided screen image showing the selected frame is transmitted to the image processing apparatus 12 by the user device 14.

According to the present configuration, it is possible to reduce a probability that the user 22 may designate an unintended user device side divided screen compared with a case where a motion picture having a frame rate higher than that of a frame-advancing motion picture is displayed. Therefore, compared with a case where the user device side divided screen is designated by the user 22 from the motion picture in a state in which the motion picture having a higher frame rate than that of the frame-advancing motion picture is displayed, it is possible to reduce a probability that the virtual viewpoint image 46C based on the captured image 46B not intended by the user 22 may be generated by the processing unit 58B.

In the example shown in FIG. 17, a form example in which the frame-advancing motion picture related to the user device side divided screen selected by the user 22 is displayed on the display 78 has been exemplified, but the technique of the present disclosure is not limited to this. For example, the whole or a part of the physical camera motion picture screen 104 (for example, one or more user device side divided screens) may be displayed as a frame-advancing motion picture.

In the above embodiment, a form example in which the user device side divided screen is selected by being touched by the user 22 via the touch panel 76A has been described, but the technique of the present disclosure is not limited to this. For example, one of imaging scenes is selected by the user 22 from a menu screen capable of specifying the plurality of imaging scenes in which at least one of an imaging position, an imaging direction, and an angle of view at which imaging is performed on an imaging region is different, and thus the captured image 46B that is a processing target may be designated.

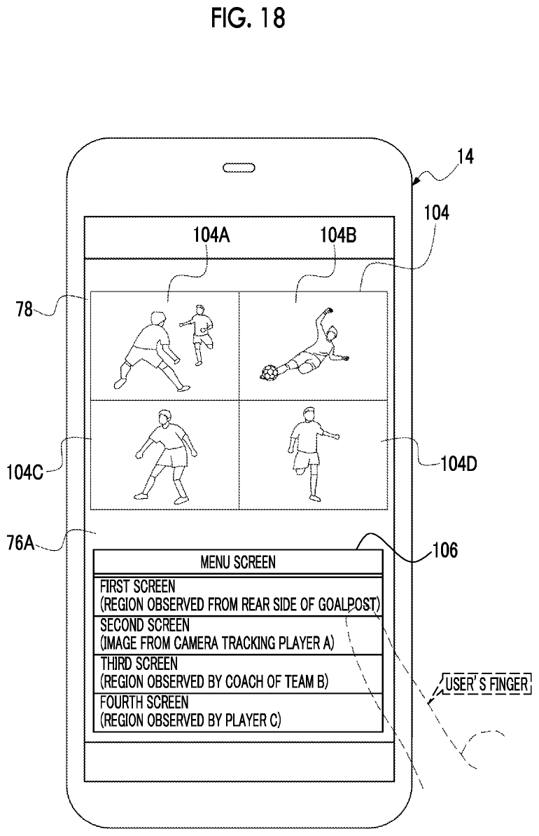

In an example shown in FIG. 18, a menu screen 106 is displayed on the display 78 in a display region different from that of the physical camera motion picture screen 104. In the menu screen 106, an item indicating what kind of imaging scene each of the images displayed on the first divided screen 104A, the second divided screen 104B, the third divided screen 104C, and the fourth divided screen 104D is shown for each user device side divided screen. The user 22 selects any item from the menu screen via the touch panel 76A. Consequently, a divided screen image showing the user device side divided screen corresponding to the item selected by the user 22 is transmitted from the user device 14 to the image processing apparatus 12, and the captured image 46B corresponding to the divided screen image is set as a processing target of the processing unit 58B.

Therefore, according to the present configuration, the user 22 can designate a user device side divided screen corresponding to an imaging scene intended by the user 22 among a plurality of imaging scenes in which at least one of an imaging position, an imaging direction, and an angle of view at which imaging is performed on the imaging region is different.

In the above embodiment, a form example in which a user device side divided screen is selected by the user 22 to designate the captured image 46B that is a processing target, but the technique of the present disclosure is not limited to this. For example, a region corresponding to an object selected from object specifying information that can specify a plurality of objects included in an imaging region may be designated as a processing target of the processing unit 58B.

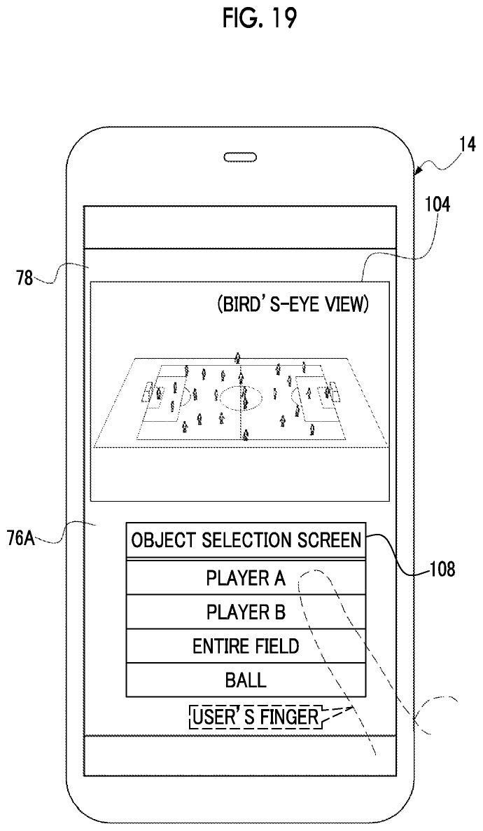

In an example shown in FIG. 19, in a case where a bird's-eye view image showing a bird's-eye view of the soccer field 24A is displayed on the physical camera motion picture screen 104, an object selection screen 108 is displayed on the display 78 in a display region different from that of the physical camera motion picture screen 104. On the object selection screen 108, object specifying information that can specify an object (for example, a player name, a soccer field, or a ball) existing in the soccer field 24A is shown to be selectable for each object. In a case where the object specifying information is selected from the object selection screen 108 by the user 22, the object specifying information selected by the user device 14 and a time at which the object specifying information is selected (hereinafter, also referred to as a “selection time”) are transmitted to the image processing apparatus 12. In the image processing apparatus 12, at least one virtual viewpoint image 46C is generated by the processing unit 58B from the image group 112 on the basis of a plurality of captured images 46B to which the same imaging time as the selection time is added and that include the object specified by the object specifying information.

The object specifying information shown on the object selection screen 108 may be registered in advance in the user device 14 or may be provided by the image processing apparatus 12. As a form example in which the object specifying information is provided from the image processing apparatus 12, there is a form example in which the object selection screen 108 is provided to the user device 14 from the server 13. As another form example, there is a form example in which a QR code (registered trademark) or the like that encrypts the object selection screen 108 is displayed on the display 100 or the like of the television receiver 18, and the QR code is imaged by the physical camera 84 of the user device 14 such that the object selection screen 108 is incorporated into the user device 14.

As described above, the user 22 can set the captured image 46B related to an object intended by the user 22 as a processing target of the processing unit 58B by designating a region corresponding to the object selected from the object specifying information that can specify a plurality of objects included in an imaging region as a processing target by the processing unit 58B.

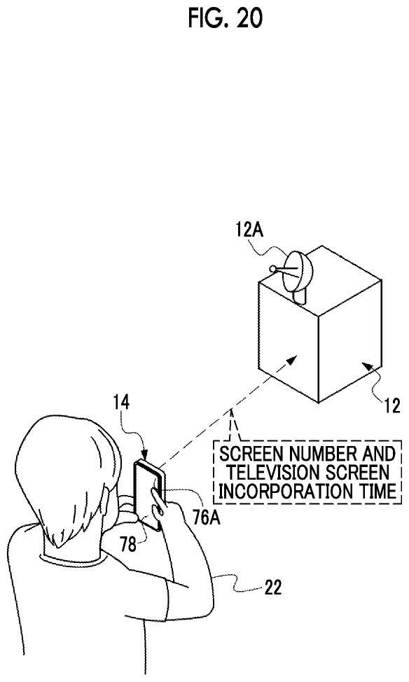

In the above embodiment, a form example in which the divided screen image is transmitted to the image processing apparatus 12 by the user device 14 has been described, but the technique of the present disclosure is not limited to this. For example, as shown in FIG. 20, instead of the divided screen image, a screen number and a television screen incorporation time may be transmitted to the image processing apparatus 12 by the user device 14. The screen number is a number that can identify any of the user device side divided screens in the physical camera motion picture screen 104. The screen number is received by, for example, the reception device 76. The television screen incorporation time refers to a time at which the screen 102 is incorporated into the user device 14. Examples of the time at which the screen 102 is incorporated into the user device 14 include a time at which an image is captured by the physical camera 84 of the user device 14, a time at which the physical camera motion picture screen 104 is generated by the user device 14, and a time at which the physical camera motion picture screen 104 is displayed on the display 78 of the user device 14.

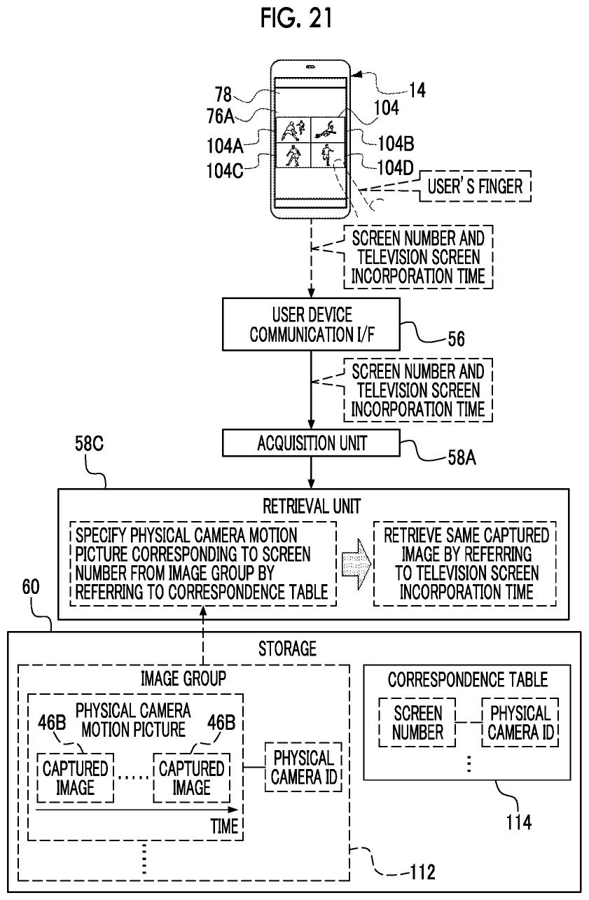

In a case where the screen number and the television screen incorporation time are transmitted to the image processing apparatus 12 by the user device 14, the screen number and the television screen incorporation time are received by the user device communication I/F 56 as shown in FIG. 21 as an example. The screen number and the television screen incorporation time received by the user device communication I/F 56 are acquired by the acquisition unit 58A.

The storage 60 stores a correspondence table 114 in which a screen number and a physical camera ID are associated with each other. A physical camera ID is associated with the screen number for each of the first physical camera 16A, the second physical camera 16B, the third physical camera 16C, and the fourth physical camera 16D.

In a case where the first physical camera 16A is changed to another physical camera, the physical camera ID of the first physical camera 16A for the screen number is updated to a physical camera ID of the changed physical camera 16 by the CPU 58. In a case where the second physical camera 16B is changed to another physical camera, the physical camera ID of the second physical camera 16B for the screen number is updated to a physical camera ID of the changed physical camera 16 by the CPU 58. In a case where the third physical camera 16C is changed to another physical camera, the physical camera ID of the third physical camera 16C for the screen number is updated to a physical camera ID of the changed physical camera 16 by the CPU 58. In a case where the fourth physical camera 16D is changed to another physical camera, the physical camera ID of the fourth physical camera 16D for the screen number is updated to a physical camera ID of the changed physical camera 16 by the CPU 58.

In a case where the first physical camera 16A is changed to another physical camera 16, the first physical camera motion picture displayed on the first divided screen 102A is switched to a physical camera motion picture obtained by being captured by the new first physical camera 16A. In a case where the second physical camera 16B is changed to another physical camera 16, the second physical camera motion picture displayed on the second divided screen 102B is switched to a physical camera motion picture obtained by being captured by the new second physical camera 16B. In a case where the third physical camera 16C is changed to another physical camera 16, the third physical camera motion picture displayed on the third divided screen 102C is switched to a physical camera motion picture obtained by being captured by the new third physical camera 16C. In a case where the 4th physical camera 16D is changed to another physical camera 16, the 4th physical camera motion picture displayed on the 4th divided screen 102D is switched to a physical camera motion picture obtained by being captured by the new fourth physical camera 16D. As described above, in a case where the physical camera motion picture displayed on the television side divided screen is switched, the image displayed on the user device side divided screen is also switched. In order to correspond to this, the physical camera ID associated with the screen number in the correspondence table 114 is also updated.

The retrieval unit 58C specifies a physical camera ID corresponding to the screen number acquired by the acquisition unit 58A. The retrieval unit 58C specifies a physical camera motion picture associated with the specified physical camera ID. The retrieval unit 58C retrieves the captured image 46B, that is, the same captured image to which the same imaging time as the television screen incorporation time acquired by the acquisition unit 58A is added from the specified physical camera motion picture.

As described above, even in a case where the screen number and the television screen incorporation time are transmitted to the image processing apparatus 12 by the user device 14 instead of the divided screen image, the same effect as that of the above embodiment can be achieved.

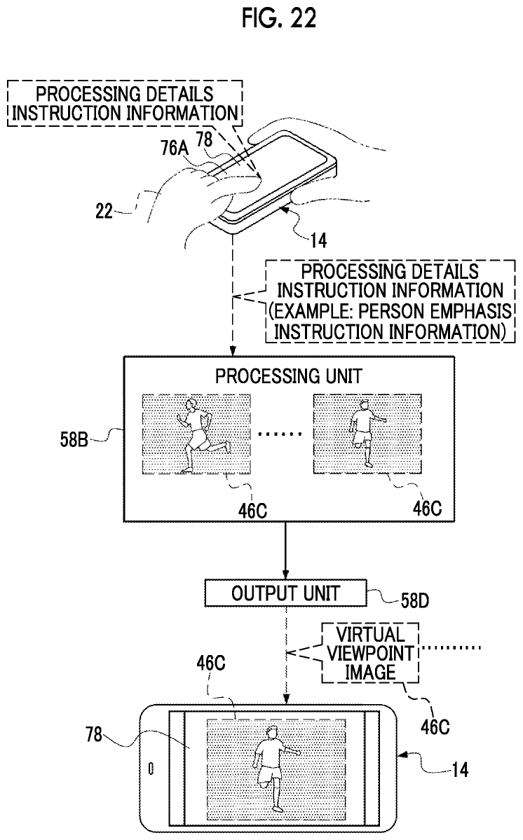

In the above embodiment, a form example in which the captured image 46B designated by the user 22 is processed by the processing unit 58B has been described, but processing details for the captured image 46B may be changed by the processing unit 58B according to an instruction given from the outside. For example, as shown in FIG. 22, in a case where processing details instruction information for giving an instruction for processing details is received by the touch panel 76A of the user device 14, the processing details instruction information is output to the processing unit 58B by the user device 14. Examples of the processing details instruction information include person emphasis instruction information for giving an instruction for emphasis of a person. In the example shown in FIG. 22, a person captured in the virtual viewpoint image 46C is emphasized by processing a person image showing the person in the virtual viewpoint image 46C to have a resolution higher than a resolution around the person image. A method of emphasizing the person captured in the virtual viewpoint image 46C is not limited to this, and a contour of the person image in the virtual viewpoint image 46C may be highlighted. At least a part of the brightness in the virtual viewpoint image 46C may be changed, or a color, a character, and/or an image designated by the user 22 may be superimposed on the virtual viewpoint image 46C.

As described above, the processing details for the captured image 46B are changed by the processing unit 58B in response to an instruction given from the outside, so that the virtual viewpoint image 46C can be finished to processing details intended by the user 22.

Here, the virtual viewpoint image 46C is a target for changing the processing details, but the technique of the present disclosure is not limited to this, and the captured image 46B may be a processed image, and an image other than the virtual viewpoint image 46C may be a target for changing the processing details. The image other than the virtual viewpoint image 46C refers to an image obtained by processing, for example, a resolution of a central portion of the captured image 46B obtained by being captured by the physical camera 16 or a person image to be higher than a resolution of other regions. In this case, an example of the processing details instruction information includes information for giving an instruction for changing the resolution of the central portion of the captured image 46B or the person image and/or the resolution of the other region.

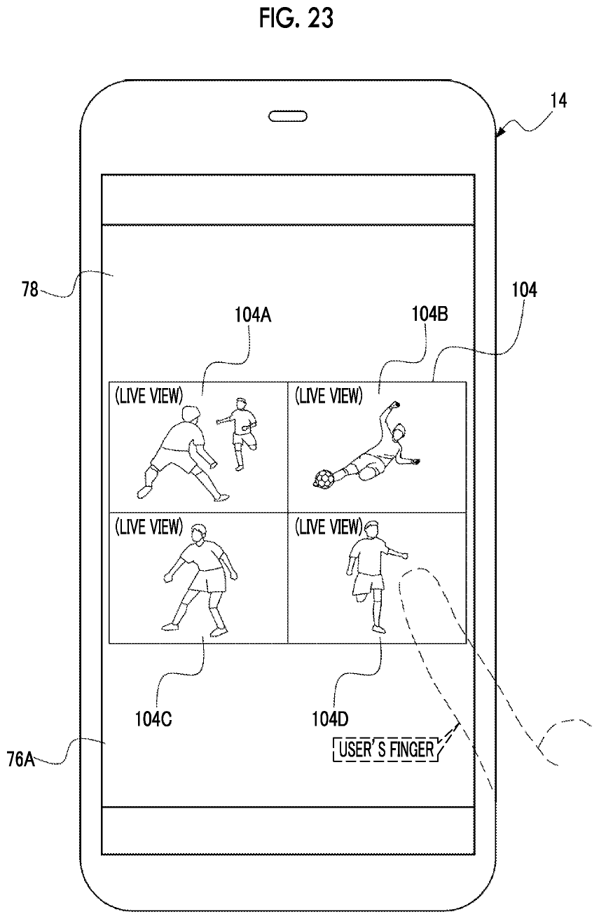

In the above embodiment, a form example in which a still image is used as the physical camera motion picture screen 104 has been described, but the technique of the present disclosure is not limited to this. For example, as shown in FIG. 23, the physical camera motion picture screen 104 may be a live view image. That is, the physical camera 84 of the user device 14 performs imaging for obtaining a live view image on the screen 102 on which the physical camera motion picture is displayed as a television video.

Consequently, a live view image obtained by imaging the first divided screen 102A on which the first physical camera motion picture is displayed as a television video with the physical camera 84 is displayed on the first divided screen 104A. A live view image obtained by imaging the second divided screen 102B on which the second physical camera motion picture is displayed as a television video with the physical camera 84 is displayed on the second divided screen 104B. A live view image obtained by imaging the third divided screen 102C on which the third physical camera motion picture is displayed as a television video with the physical camera 84 is displayed on the third divided screen 104C. A live view image obtained by imaging the fourth divided screen 102D on which the fourth physical camera motion picture is displayed as a television video with the physical camera 84 is displayed on the fourth divided screen 104D.

In a case where any of the user device side divided screens is selected by the user 22 via the touch panel 76A, the captured image 46B corresponding to a frame displayed on the user device side divided screen at the selection timing is designated as a processing target of the processing unit 58B. The processing unit 58B generates the virtual viewpoint image 46C on the basis of the designated captured image 46B, and the output unit 58D outputs the virtual viewpoint image 46C generated by the processing unit 58B to the user device 14. That is, the CPU 58 generates and outputs the virtual viewpoint image 46C with reference to a timing at which the captured image 46B is designated.

According to the present configuration, the virtual viewpoint image 46C generated at a timing closer to the timing intended by the user 22 can be provided to the user 22 compared with a case where the virtual viewpoint image 46C is generated without considering a timing at which the captured image 46B is designated.

Here, the virtual viewpoint image 46C is exemplified as a processed image of the captured image 46B, but the technique of the present disclosure is not limited to this, and an image other than the virtual viewpoint image 46C may be used as long as the captured image 46B designated by the user 22 is an image processed by the processing unit 58B.

In the above embodiment, a form example in which the screen 102 is imaged by the physical camera 84 of the user device 14 has been described, but the technique of the present disclosure is not limited to this, and the physical camera motion picture may be directly displayed on the user device 14 as a television video. In this case, it is not necessary to incorporate the screen 102 into the user device 14.

In this case, a physical camera motion picture obtained by being captured by any one of the plurality of physical cameras 16 may be displayed on the user device 14, or a plurality of physical camera motion pictures obtained by the being captured by the plurality of physical cameras 16 may be displayed on the display 78 of the user device 14. In a case where the physical camera motion picture is directly displayed on the display 78 of the user device 14, the motion picture may be paused at a timing intended by the user 22. Consequently, it becomes easier for the user 22 to generate a virtual viewpoint image corresponding to a target image.

In the above embodiment, a form example in which the screen 102 is divided into four regions has been described, but this is only an example, and the number of divisions of the screen 102 may be any number.

In the above embodiment, a form example in which the display 100 includes a plurality of television side divided screens has been described, but the plurality of television side divided screens may be displayed separately on a plurality of displays. That is, at least one of the plurality of television side divided screens may be displayed on another display. For example, the first divided screen 102A, the second divided screen 102B, the third divided screen 102C, and the fourth divided screen 102D may be respectively displayed on different displays.

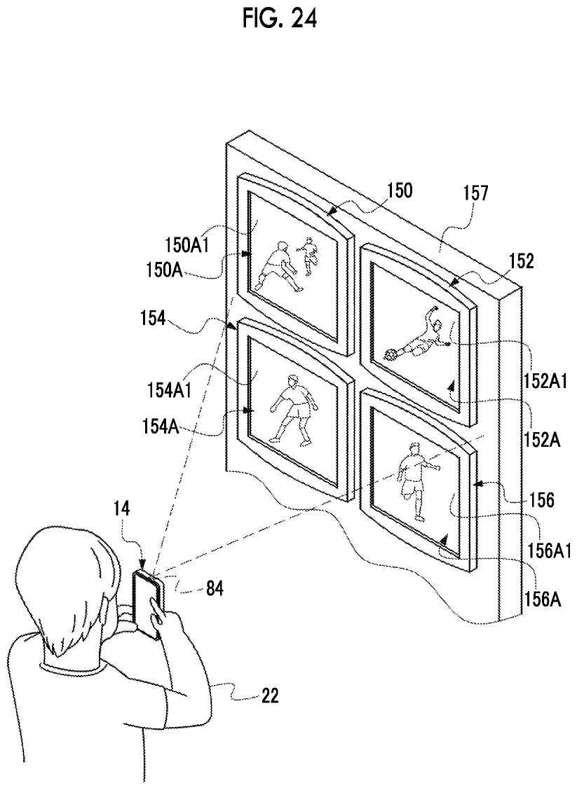

For example, as shown in FIG. 24, a screen 150A1 may be displayed on a display 150A of a television receiver 150, a screen 152A1 may be displayed on a display 152A of a television receiver 152, a screen 154A1 may be displayed on a display 154A of a television receiver 154, and a screen 156A1 may be displayed on a display 156A of a television receiver 156.

In this case, for example, the screen 150A1 may display the first physical camera motion picture as in the first divided screen 102A described in the above embodiment, the screen 152A1 may display the second physical camera motion picture as in the second divided screen 102B described in the above embodiment, the screen 154A1 may display the third physical camera motion picture as in the third divided screen 102C described in the above embodiment, and the screen 156A1 may display the fourth physical camera motion picture as in the fourth divided screen 102D described in the above embodiment.

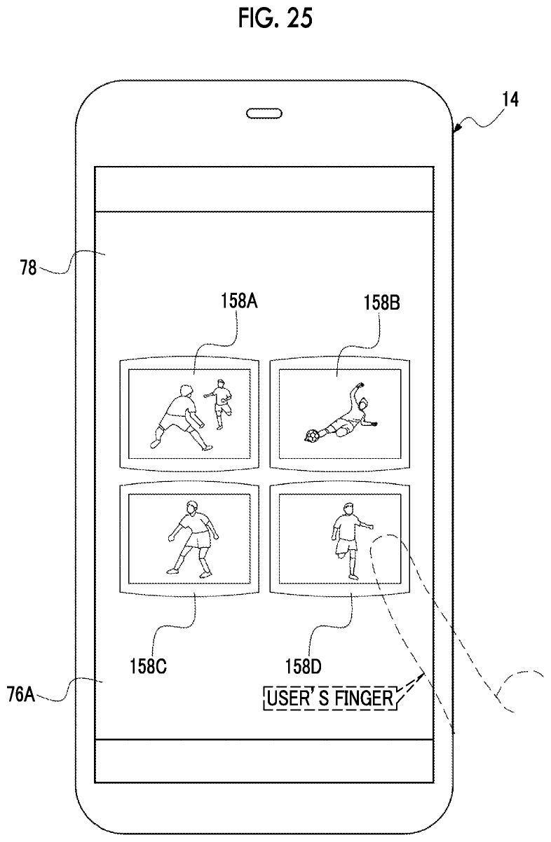

In this case as well, the screens 150A1, 152A1, 154A1 and 156A1 may be imaged by the physical camera 84 of the user device 14 in the same manner as in the above embodiment. That is, in this case, the screens of the four television receivers are present in the imaging region of the physical camera 84. By imaging the screens 150A1, 152A1, 154A1 and 156A1 with the physical camera 84, for example, as shown in FIG. 25, the display 78 of the user device 14 displays a screen 158A that is an image showing the screen 150A1, a screen 158B that is an image showing the screen 152A1, a screen 158C that is an image showing the screen 154A1, and a screen 158D that is an image showing the screen 156A1. The screen 158A is a screen corresponding to the first divided screen 104A described in the above embodiment, the screen 158B is a screen corresponding to the second divided screen 104B described in the above embodiment, the screen 158C is a screen corresponding to the third divided screen 104C described in the above embodiment, and the screen 158D is a screen corresponding to the fourth divided screen 104D described in the above embodiment.

In the example shown in FIG. 24, a form example in which the television receivers 150, 152, 154 and 156 are attached to a board 157 is shown, but an installation form and an installation number of the television receivers 150, 152, 154 and 156 are not limited to this. For example, at least one of the television receivers 150, 152, 154, and 156 may be a stand-type television receiver, a hanging type television receiver, or a cantilever type television receiver, and an installation number may be any number.

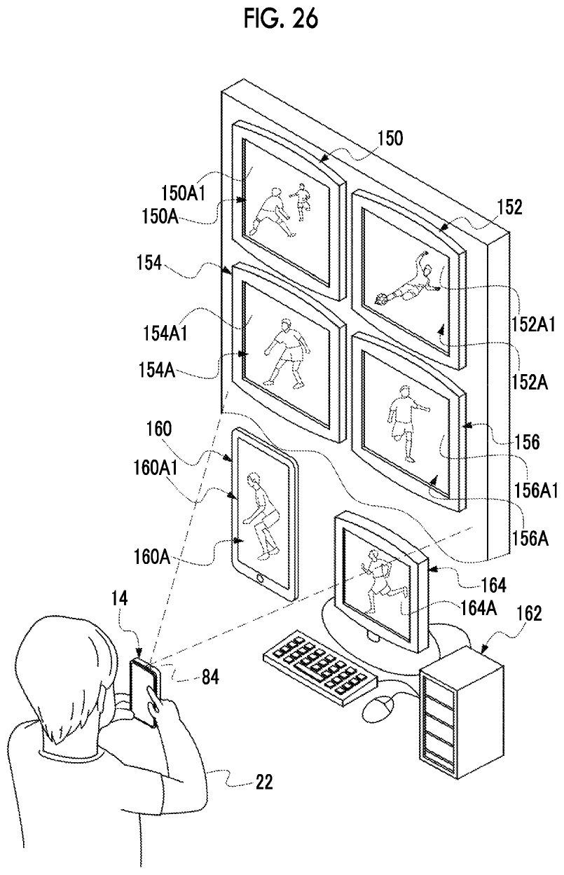

Although the display of the television receiver has been exemplified above, the technique of the present disclosure is not limited to this, and for example, as shown in FIG. 26, a display 160A of a tablet terminal 160 and a display 164 connected to a personal computer 162 may be used. In the example shown in FIG. 26, a physical camera motion picture is displayed on each of the screen 160A1 of the display 160A and the screen 164A1 of the display 164A. Also in this case, similarly to the example shown in FIG. 24, the screens 150A1, 152A1, 154A1, 156A1, 160A1, and 164A1 may be imaged by the physical camera 84 of the user device 14. In the example shown in FIG. 26, the desktop type personal computer 162 is exemplified, but the present disclosure is not limited to this, and a notebook type personal computer may be used.

In the example shown in FIG. 26, the screen 160A1 of the display 160A of the tablet terminal 160 and the screen 164A1 of the display 164A connected to the personal computer 162 have been exemplified, but a screen formed by another type of device such as a screen of a display of a smartphone and/or a screen projected by a projector may be used. The technique of the present disclosure is not limited to a screen on which a physical camera motion picture is displayed, and may be applied to a screen on which a processed image (for example, a virtual viewpoint) obtained by processing an image obtained by being captured is displayed.

In the above embodiment, the case where the physical camera motion picture screen 104 is a still image has been exemplified, but the present disclosure is not limited to this, and the physical camera motion picture screen 104 may be a motion picture. In this case, among a plurality of time-series images (images for one frame showing the physical camera motion picture screen 104) configuring a motion picture displayed on the display 78 of the user device 14, an image intended by the user 22 may be selectively displayed on the display 78 by the user 22 performing a flick operation, a swipe operation, and/or a tap operation on the touch panel 76A.

In the above embodiment, a form example in which a physical camera motion picture obtained by being captured by the physical camera 16 is displayed on the screen 102 has been described, but the technique of the present disclosure is not limited to this. A virtual viewpoint motion picture configured with a plurality of virtual viewpoint images 46C obtained by being captured by the virtual camera 42 may be displayed on the screen 102. The physical camera motion picture and the virtual viewpoint motion picture may be displayed on separate divided screens in the screen 102. The image is not limited to a motion picture, and may be a still image or a consecutively captured image.

In the above embodiment, the soccer stadium 24 has been exemplified, but this is only an example, and any place may be used as long as a plurality of physical cameras 16 can be installed, such as a baseball field, a rugby field, a curling field, an athletic field, a swimming pool, a concert hall, an outdoor music field, and a theatrical play venue.

In the above embodiment, the computers 50 and 70 have been exemplified, but the technique of the present disclosure is not limited to this. For example, instead of the computers 50 and/or 70, devices including ASICs, FPGAs, and/or PLDs may be applied. Instead of the computer 50 and/or 70, a combination of hardware configuration and software configuration may be used.

In the above embodiment, a form example in which the processing output process is executed by the CPU 58 of the image processing apparatus 12 has been described, but the technique of the present disclosure is not limited to this. Some of the processes included in the processing output process may be executed by the CPU 88 of the user device 14. Instead of the CPU 88, a GPU may be employed, or a plurality of CPUs may be employed, and various processes may be executed by one processor or a plurality of physically separated processors.

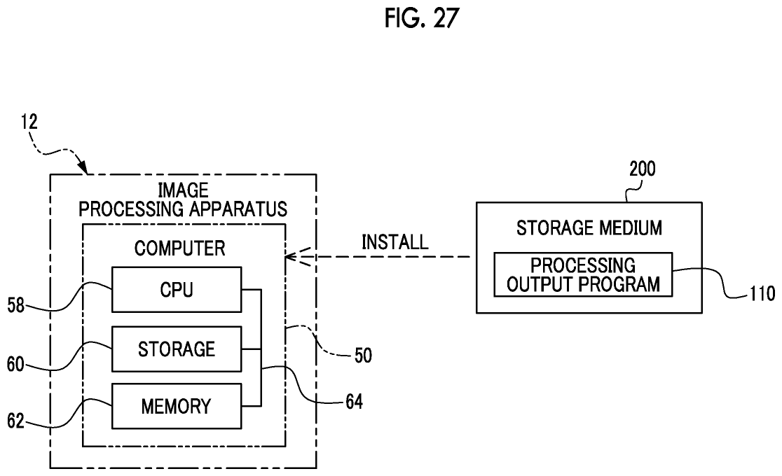

In the above embodiment, the processing output program 110 is stored in the storage 60, but the technique of the present disclosure is not limited to this, and as shown in FIG. 27 as an example, the processing output program 110 may be stored in any portable storage medium 200. The storage medium 200 is a non-transitory storage medium. Examples of the storage medium 200 include an SSD and a USB memory. The processing output program 110 stored in the storage medium 200 is installed in the computer 50, and the CPU 58 executes the processing output process according to the processing output program 110.

The processing output program 110 may be stored in a program memory of another computer, a server device, or the like connected to the computer 50 via a communication network (not shown), and the processing output program 110 may be downloaded to the image processing apparatus 12 in response to a request from the image processing apparatus 12. In this case, the processing output process based on the downloaded processing output program 110 is executed by the CPU 58 of the computer 50.

As a hardware resource for executing the processing output process, the following various processors may be used. Examples of the processor include, as described above, a CPU that is a general-purpose processor that functions as a hardware resource that executes the processing output process according to software, that is, a program.

As another processor, for example, a dedicated electric circuit which is a processor such as an FPGA, a PLD, or an ASIC having a circuit configuration specially designed for executing a specific process may be used. A memory is built in or connected to each processor, and each processor executes the processing output process by using the memory.

The hardware resource that executes the processing output process may be configured with one of these various processors, or a combination of two or more processors of the same type or different types (for example, a combination of a plurality of FPGAs, or a combination of a CPU and an FPGA). The hardware resource that executes the processing output process may be one processor.

As an example of configuring a hardware resource with one processor, first, there is a form in which one processor is configured by a combination of one or more CPUs and software, as typified by a computer used for a client or a server, and this processor functions as the hardware resource that executes the processing output process. Second, as typified by system on chip (SoC), there is a form in which a processor that realizes functions of the entire system including a plurality of hardware resources executing the processing output process with one integrated circuit (IC) chip is used. As described above, the processing output process is realized by using one or more of the above various processors as hardware resources.

As a hardware structure of these various processors, more specifically, an electric circuit in which circuit elements such as semiconductor elements are combined may be used.

The processing output process described above is only an example. Therefore, needless to say, unnecessary steps may be deleted, new steps may be added, or the processing order may be changed within the scope without departing from the spirit.

The content described and exemplified above are detailed descriptions of the portions related to the technique of the present disclosure, and are only an example of the technique of the present disclosure. For example, the above description of the configuration, the function, the operation, and the effect is an example of the configuration, the function, the operation, and the effect of the portions of the technique of the present disclosure. Therefore, needless to say, unnecessary portions may be deleted, new elements may be added, or replacements may be made to the described content and illustrated content shown above within the scope without departing from the spirit of the technique of the present disclosure. In order to avoid complications and facilitate understanding of the portions related to the technique of the present disclosure, in the description content and the illustrated content shown above require special description, description of common technical knowledge or the like that does not require particular description in order to enable the implementation of the technique of the present disclosure is omitted.

In the present specification, “A and/or B” is synonymous with “at least one of A or B”. That is, “A and/or B” means that it may be only A, only B, or a combination of A and B. In the present specification, in a case where three or more matters are connected and expressed by “and/or”, the same concept as “A and/or B” is applied.

All the documents, the patent applications, and the technical standards disclosed in the present specification are incorporated by reference in the present specification to the same extent as in a case where the individual documents, patent applications, and technical standards are specifically and individually stated to be incorporated by reference.

What is claimed is:

1. An image processing apparatus comprising:
a processor; and
a memory built in or connected to the processor,
wherein the processor
acquires specific region information indicating a specific region designated in an imaging region image screen on which an imaging region image obtained by imaging an imaging region is displayed, and
outputs a specific region processed image obtained by processing an image corresponding to the specific region indicated by the specific region information among a plurality of images obtained by imaging the imaging region.

2. The image processing apparatus according to claim 1,
wherein the imaging region image screen is a screen obtained by imaging another screen on which the imaging region image is displayed.

3. The image processing apparatus according to claim 1,
wherein the imaging region image includes a live broadcast video.

4. The image processing apparatus according to claim 1,
wherein the imaging region image screen has a plurality of divided screens on which the imaging region image is displayed, and
the specific region is designated by selecting any of the divided screens.

5. The image processing apparatus according to claim 4,
wherein the imaging region image is divided and displayed on the plurality of divided screens.

6. The image processing apparatus according to claim 4,
wherein the imaging region image is a plurality of unique images obtained by imaging the imaging region in different imaging methods, and
the plurality of unique images are respectively and individually displayed on the plurality of divided screens.

7. The image processing apparatus according to claim 4,
wherein the plurality of divided screens are displayed separately on a plurality of displays.

8. The image processing apparatus according to claim 1,
wherein the processor generates and outputs the specific region processed image with reference to a timing at which the specific region is designated.

9. The image processing apparatus according to claim 1,
wherein the imaging region image is displayed on a display as a frame-advancing motion picture, and
the specific region is designated by selecting any of a plurality of frames configuring the frame-advancing motion picture.

10. The image processing apparatus according to claim 1,
wherein, from a menu screen capable of specifying a plurality of imaging scenes in which at least one of a position, an orientation, or an angle of view at which imaging is performed on the imaging region is different, the specific region is designated by selecting any of the plurality of imaging scenes.

11. The image processing apparatus according to claim 1,
wherein a region corresponding to an object selected from object specifying information capable of specifying a plurality of objects included in the imaging region is designated as the specific region.

12. The image processing apparatus according to claim 1,
wherein the processor outputs the specific region processed image to a display device to display the specific region processed image on the display device.

13. The image processing apparatus according to claim 1,
wherein the processor changes processing details for an image for the specific region according to an instruction given from an outside.

14. The image processing apparatus according to claim 1,
wherein the specific region processed image is a virtual viewpoint image.

15. An image processing method comprising:
acquiring specific region information indicating a specific region designated in an imaging region image screen on which an imaging region image obtained by imaging an imaging region is displayed; and
outputting a specific region processed image obtained by processing an image corresponding to the specific region indicated by the specific region information among a plurality of images obtained by imaging the imaging region and including a virtual viewpoint image.

16. A non-transitory computer-readable storage medium storing a program executable by a computer to perform a process:
acquiring specific region information indicating a specific region designated in an imaging region image screen on which an imaging region image obtained by imaging an imaging region is displayed; and
outputting a specific region processed image obtained by processing an image corresponding to the specific region indicated by the specific region information among a plurality of images obtained by imaging the imaging region and including a virtual viewpoint image.
